(19) United States
(12) Patent Application Publication
(10) Pub. No.: US 2006/0203217 A1
(43) Pub. Date: Sep. 14, 2006

(54) Optical adjustment device, optical pickup apparatus provided with optical adjustment device, and method and apparatus for assembling optical adjustment device

(75) Inventors: Masahiro Nakamura, Higashihiroshima-shi (JP); Hironobu Shitamura, Higashihiroshima-shi (JP)

Correspondence Address: MORRISON & FOERSTER LLP, 755 PAGE MILL RD, PALO ALTO, CA, 94304-1018, US

(73) Assignee: SHARP KABUSHIKI KAISHA, Osaka-shi (JP)

(21) Appl. No.: 11/373,683

(22) Filed: Mar. 10, 2006

(30) Foreign Application Priority Data
Mar. 10, 2005 (JP) JP2005-067669
Jun. 6, 2005 (JP) JP2005-165884
Dec. 14, 2005 (JP) JP2005-360831

(51) Int. Cl. G03B 27/42

(52) U.S. Cl. 355/53

(57) ABSTRACT

An optical adjustment device capable of correcting spherical aberration with high accuracy in a simple configuration is provided. A second lens holder fits into a guiding portion of a first lens holder, and a grip rack is placed across the second lens holder and a feed screw member and resiliently abuts against the feed screw member. The driving force of a driving source is transmitted to the grip rack via the feed screw member, and the grip rack is displaced. Therefore, it is possible to displace the second lens holder with respect to the first lens holder, and adjust the spherical aberration of an optical system.

### BACKGROUND OF THE INVENTION

1. Field of the Invention

The present invention relates to an optical adjustment device which adjusts the spherical aberration of an optical system of an optical pickup apparatus, an optical pickup apparatus provided with the optical adjustment device, and a method and apparatus for assembling the optical adjustment device.

2. Description of the Related Art

Although a magnetic recording method has been much used as a method for recording information, an optical recording method in which light is used for recording and reproducing information has come to be used in response to a demand for increase of information recording capacity. An optical recording medium is a recording medium which is of a large capacity and has an advantage of being rewritable and medium-exchangeable, and there are optical recording media based on a variety of standards, such as a compact disk (abbreviated to CD) and a family disk thereof, and a digital versatile disk (abbreviated to DVD) and a family disk thereof.

Although an optical recording medium is a recording medium which has a large recording capacity as compared with a recording medium of the magnetic recording method, a higher recording density and a larger capacity have been still demanded of the optical recording medium.

An optical system of an information recording and reproducing apparatus which executes at least one of a process of recording information onto an optical recording medium and a process of reproducing information of the optical recording medium needs reduction of the light spot diameter of light condensed onto an information recording surface of the optical recording medium for the purpose of making the density of recording signals higher. In order to reduce the light spot diameter, a method of increasing the numerical aperture (abbreviated to NA) of an objective lens and shortening the wavelength of a laser beam emitted from a semiconductor laser device serving as a light source is adopted.

However, the spherical aberration of an objective lens gets larger in proportion to the fourth power of the NA of the objective lens and the thickness of an optical transparent layer of an optical recording medium, so that in a case where the NA of the objective lens is increased in order to reduce the spot diameter of a laser beam, there arises a problem that the spherical aberration gets larger as compared with that of an objective lens having a low NA. For example, the NA of a much used objective lens is about 0.6, but in a case where the NA of the objective lens is higher than 0.6, concretely, 0.8 or more and less than 0.9, the amount of spherical aberration increases three times or more and less than five times as compared with that of the objective lens having an NA of about 0.6. Therefore, in an optical pickup apparatus loaded in the information recording and reproducing apparatus, a method of correcting spherical aberration by adjusting the interval between two correcting lenses disposed so that the relative positions are variable is adopted.

FIG. 23 is a view showing the optical layout of a related art optical pickup apparatus 1. FIG. 24 is a simplified perspective view showing the related art optical pickup apparatus 1. The optical pickup apparatus 1 comprises a semiconductor laser device serving as a light source which is not shown in the figures, a concave lens 2 disposed on an optical axis L1 of light emitted from the semiconductor laser device, a convex lens 3, a raising mirror 4 and an objective lens 5, wherein the light emitted from the semiconductor laser device is applied to an optical disk 6 serving as the optical recording medium, information is written and recorded onto the optical disk 6, and also information written on the optical disk 6 is reproduced.

FIG. 25 is a perspective view showing a first related art optical adjustment device 10. FIG. 26 is an exploded perspective view showing the optical adjustment device 10. FIG. 27 is a plan view showing the optical adjustment device 10. FIG. 28 is a front view showing the optical adjustment device 10. In FIG. 28, a gear storage table 40 placed on a base 41 is shown in a manner that part thereof on the side of the first lens holder is omitted.

The optical adjustment device 10 is a device which, in a case where spherical aberration is caused by an error in thickness of the optical disk 6, adjusts the spherical aberration. The optical adjustment device 10 is disposed between the semiconductor laser device serving as a light source and the objective lens 5 that condenses light. The optical adjustment device 10 has the concave lens 2, the convex lens 3 formed in pairs (simply referred to as “convex lens” hereinafter), a second lens holder 11, a first lens holder 20, a guide shaft 25, a driving sours 30, a first reduction gears 31, a second reduction gears 32, a third reduction gears 33, a fourth reduction gears 34, a feed screw member 35, and a grip rack 36. On the second lens holder 11 is placed the concave lens 2. On the first lens holder 20 is placed the convex lens 3. The guide shaft 25 guides the second lens holder 11 in an approaching and leaving direction A, which is an approaching direction of causing the concave lens 2 to approach the convex lens 3 and a leaving direction of causing the concave lens 2 to leave the convex lens 3. The driving source 30 drives the second lens holder 11. The first, second, third and fourth reduction gears 31, 32, 33 and 34 transmit the driving force of the driving source 30 to a feed screw member 35. The feed screw member 35 engages with the fourth reduction gear 34. The grip rack 36 fits to the feed screw member 35.

The first to fourth reduction gears 31 to 34, the feed screw member 35, and the driving source 30 are built into the gear storage table 40. Further, the gear storage table 40 and the first lens holder 20 are placed on the base 41.

The second lens holder 11 is formed into an almost rectangular parallelepiped. The second lens holder 11 is provided with a concave lens placement portion 12 on which the concave lens 2 is placed. The concave lens placement portion 12 is formed along the axis of the concave lens 2 so as to pass through the second lens holder 11. The second lens holder 11 is provided with a guide hole 13 in which the guide shaft 25 is inserted. The guide hole 13 is formed so as to extend in a direction parallel to the axis of the concave lens 2.

On one side face portion of the second lens holder 11, a guiding projection 14 that projects from the one side face portion in a direction perpendicular to both the thickness direction of the second lens holder 11 and the approaching and leaving direction A is disposed. Moreover, on one surface portion in the thickness direction of the second lens holder 11, a first top-face projection 15 and a second top-face projection 16 that project in one direction of the thickness direction of the second lens holder 11 from the one surface portion are disposed. The first top-face projection 15 fits into a rack hole 37 of the grip rack 36, and the second top-face projection 16 fits into a notch 38 of the grip rack 36.

The first lens holder 20 is provided with a convex lens placement portion 21 on which the convex lens 3 is placed, and a depressed portion 22 and a shaft hole 23 into which the guide shaft 25 fits. Moreover, on the first lens holder 20, a guide groove 24 is formed so as to engage with the guiding projection 14 of the second lens holder 11 and extend in a direction parallel to the axis of the convex lens 3. The grip rack 36 is provided with the rack hole 37 into which the first top-face projection 15 of the second lens holder 11 fits, and the notch 38 into which the second top-face projection 16 of the second lens holder 11 fits. Moreover, the grip rack 36 has a locking portion 39 that fits to the feed screw member 35.

Into the depressed portion 22 and the shaft hole 23 formed on the first lens holder 20 and the guide hole 13 formed on the second lens holder 11, the guide shaft 25 is inserted. The depressed portion 22, the shaft hole 23, and the guide hole 13 are formed so that the guide shaft 25 becomes parallel to the axis of the convex lens 3, respectively. Further, the guiding projection 14 of the second lens holder 11 and the guide groove 24 of the first lens holder 20 engage with each other.

The driving force of the driving source 30 is transmitted to the feed screw member 35 via the first to fourth reduction gears 31 to 34, and the feed screw member 35 is rotated, whereby the grip rack 36 fitting to the feed screw member 35 is displaced in the approaching and leaving direction A. Consequently, as the grip rack 36 is displaced, the second lens holder 11 engaging with the grip rack 36 is guided along the guide shaft 25 and the guide groove 24 with which the guiding projection 14 engages, and displaced in the approaching and leaving direction A. Therefore, the optical adjustment device 10 makes it possible to displace the second lens holder 11 on which the concave lens 2 is placed in the approaching and leaving direction A when spherical aberration is caused, thereby adjusting the relative position to the first lens holder 20, and adjusting the spherical aberration.

A second related art optical adjustment device is an optical adjustment device disclosed in Japanese Unexamined Patent Publication JP-A 2003-45068, for example. The second related art optical adjustment device has: a stepping motor serving as driving means; a lens holder; a guide rail which is disposed to the lens holder and parallel to the optical axial direction of a lens; a knife edge which is disposed to the lens holder and fits to a feed screw; and a spring which biases the knife edge toward the feed screw. In the second related art optical adjustment device, the feed screw is rotated based on rotation of the stepping motor, the knife edge fitting to the feed screw is displaced, and the lens holder is thereby displaced along the guide rail in the optical axis direction of the lens, with the result that it is possible to adjust spherical aberration.

In the first related art optical adjustment device 10, the second lens holder 11 formed into an almost rectangular parallelepiped is provided on the first lens holder 20, and a plurality of guides, such as the guiding projection 14 and the guide shaft 25, are disposed so that the second lens holder 11 is displaced with respect to the first lens holder 20. Therefore, there is a problem that components count increases, the structure is complicated and the device is upsized. Further, since the grip rack 36 is disposed across the second lens holder 11 and the screw member 35, and the locking portion 39 of the grip rack 36 is just fitted to the feed screw member 35, there is a problem that the fitting state is released by external shock or the like and dislocation is caused.

In the second related art optical adjustment device, the knife edge is pressed against the feed screw by the spring and thereby fitted without fluctuation, and the lens holder can be displaced in the optical axis direction of the lens, but the device needs a plurality of guide rails, which causes increase of components count, complication of the structure and upsizing of the device.

### SUMMARY OF THE INVENTION

An object of the invention is to provide an optical adjustment device capable of correcting spherical aberration with high accuracy in a simple configuration, and an optical pickup apparatus provided with the same. Another object of the invention is to provide an optical adjustment device which makes it possible to displace a second lens holder with respect to a first lens holder without fluctuation, further reduce components count and realize simplification and downsizing of the device, a method for assembling the optical adjustment device, and an apparatus for assembling the optical adjustment device.

The invention provides an optical adjustment device which adjusts the spherical aberration of an optical system of an optical pickup apparatus by adjusting relative positions of a first lens and a second lens, the optical adjustment device comprising:

a first lens holder having a substantially C-shaped guiding portion, for holding the first lens;

a second lens holder for holding the second lens, the second lens holder having one outwardly protruding convex portion formed in a circumferential direction thereof, the second lens holder being structured such as to fit into the guiding portion of the first lens holder and be freely displaceable with respect to the first lens holder by guidance of both circumferential ends of the convex portion by both circumferential ends of the guiding portion;

a driving source;

a screw-like member rotationally driven by the driving source; and

a connecting member which is provided on one of the first lens holder and the second lend holder and has a locking portion fitting to the screw-like member.

According to the invention, the second lens holder that has one outwardly protruding convex portion formed in the circumferential directions structured such as to fit into the substantially C-shaped guiding portion of the first lens holder, and such that both the circumferential ends of the convex portion of the second lens holder are guided by both the circumferential ends of the guiding portion of the first lens holder. Moreover, the connecting member is provided on one of the first and second lens holders, and further, the locking portion disposed to the connecting member is formed so as to fit to the screw-like member. Consequently, the driving force of the driving source can be transmitted to the connecting member via the screw-like member, one of the first and second lens holders is displaced as the connecting member is displaced, and the second lens holder can be displaced along the substantially C-shaped guiding portion of the first lens holder. Therefore, it is possible to displace the second lens holder with respect to the first lens holder without the need for a plurality of guides, so that it is possible to realize an optical adjustment device in a simple configuration, and it is possible to adjust the spherical aberration of an optical system of an optical pickup apparatus. Moreover, it is possible to realize simplification and downsizing of an optical adjustment device.

Further, in the invention, it is preferable that the connecting member resiliently abuts against the screw-like member.

According to the invention, the connecting member can resiliently abut against the screw-like member, and it is possible to cause the locking portion of the connecting member to fit to the screw-like member. Therefore, in a case where the screw-like member is rotationally driven by the driving force of the driving source, and the connecting member is displaced, the connecting member can be displaced as the screw-like member rotates. Accordingly, it is possible to prevent the fitting state of the screw-like member and the connecting member from being released by external shock or the like and dislocation from being caused. Moreover, it is possible to prevent a frictional force from being produced between the connecting member and the screw-like member and the respective members from being damaged, so that it is possible to realize a highly reliable optical adjustment device. In other words, it is possible to maintain a load at the time of movement of the connecting member to be constant, and it is possible to avoid a fault in operation caused by increase and decrease of the load.

Further, the driving force of the driving source is transmitted to the connecting member via the screw-like member, and the connecting member can be displaced as the screw-like member rotates, so that it is possible to displace the second lens holder with respect to the first lens holder, and adjust the spherical aberration of an optical system of an optical pickup apparatus.

Furthermore, in the invention, it is preferable that: the first lens holder has portions abutting against both the circumferential ends of the convex portion in the guiding portion; both the circumferential ends include one and the other circumferential ends; and the abutting portions are formed into curved shapes that protrude to at least one of the sides of the one and the other circumferential ends.

According to the invention, in the guiding portion of the first lens holder, the portions abutting against the one and the other circumferential ends of the convex portion formed on the second lens holder are formed into curved shapes that protrude to at least one of the sides of the one and the other circumferential ends. Consequently, when adjusting the relative positions of the first lens holder and the second lens holder, it is possible to make the area of a portion where the second lens holder abuts against and slides on the first lens holder small to make sliding friction small, so that it is possible to reduce a sliding load at the sliding portion. Therefore, it is possible to position the first lens holder and the second lens holder with high accuracy, and it becomes possible to adjust spherical aberration with high accuracy, that is, correct spherical aberration with high accuracy.

Still further, in the invention, it is preferable that the second lens holder includes a sliding portion which slides on the first lens holder and does not include both the circumferential ends; and in the sliding portion, such portions are formed into curved shapes that are formed by one and the other ends in a displacement direction in which the second lens holder is displaced with respect to the first lens holder, and outer circumferential edges on the outer circumferential side in the radial direction of one and the other end face portions of the second lens holder.

According to the invention, in the sliding portion of the second lens holder, such portions are formed into curved shapes that are formed by the one and the other ends in the displacement direction where the second lens holder is displaced with respect to the first lens holder, and the outer circumferential edges on the outer circumferential side in the radial direction of the one and the other end face portions of the second lens holder. Consequently, when adjusting the relative positions of the first lens holder and the second lens holder, it is possible to make the area of a sliding portion where the second lens holder abuts against and slides on the first lens holder small to make sliding friction small, so that it is possible to reduce a sliding load at the sliding portion. Therefore, it is possible to position the first lens holder and the second lens holder with high accuracy, and it becomes possible to adjust spherical aberration with high accuracy, that is, to correct spherical aberration with high accuracy.

Still further, in the invention, it is preferable that the second lens holder includes a sliding portion which slides on the first lens holder and does not include both the circumferential ends; and a lubricant is applied to the sliding portion.

According to the invention, a lubricant is applied to the sliding portion of the second lens holder. Consequently, when adjusting the relative positions of the first lens holder and the second lens holder, it is possible to make sliding friction at a sliding portion where the second lens holder abuts against and slides on the first lens holder small, so that it is possible to reduce a sliding load at the sliding portion. Therefore, it is possible to position the first lens holder and the second lens holder with high accuracy, and it becomes possible to adjust spherical aberration with high accuracy, that is, to correct spherical aberration with high accuracy.

Still further, in the invention, it is preferable that the second lens holder includes a sliding portion which slides on the first lens holder and does not include both the circumferential ends and a coating process for reducing sliding friction is applied to the sliding portion.

According to the invention, the coating process for reducing sliding friction is applied to the sliding portion of the second lens holder. Consequently, when adjusting the relative positions of the first lens holder and the second lens holder, it is possible to make sliding friction at a sliding portion where the second lens holder abuts against and slides on the first lens holder small, so that it is possible to reduce a sliding load at the sliding portion. Therefore, it is possible to position the first lens holder and the second lens holder with high accuracy, and it becomes possible to adjust spherical aberration with high accuracy, that is, correct spherical aberration with high accuracy.

Still further, in the invention, it is preferable that the connecting member is provided on the second lens holder, and has the locking portion disposed at one longitudinal end and a projection disposed at the other longitudinal end and supported by the second lens holder, and at the time of adjustment of the relative positions of the first lens holder and the second lens holder, the projection of the connecting member slides on the first lens holder.

According to the invention, the connecting member is provided on the second lens holder. The connecting member has the locking portion disposed at the one longitudinal end, and the projection disposed at the other longitudinal end and supported by the second lens holder. At the time of adjustment of the relative positions of the first lens holder and the second lens holder, the projection of the connecting member slides on the first lens holder. Consequently, most of the sliding load is borne between the projection of the connecting member and the first lens holder on which the projection slides, and it is possible to reduce the sliding load at the sliding portion of the first lens holder and the second lens holder.

Still further, in the invention, it is preferable that the connecting member is provided with a detachment prevention portion which prevents the locking portion of the connecting member from being detached from the screw-like member.

Since the locking portion of the connecting member provided on the second lens holder is fitted to the screw-like member, and the projection is supported by the second lens holder, it is possible to prevent the second lens holder from unevenly contacting the guiding portion of the first lens holder, when the relative positions of the first lens holder and the second lens holder are adjusted and the second lens holder is guided into the guiding portion of the first lens holder. Consequently, it is possible to reduce a sliding load of the first lens holder and the second lens holder.

According to the invention, by providing the connecting member with the detachment prevention portion for preventing the locking portion of the connecting member from being detached from the screw-like member, it is possible to prevent the locking portion of the connecting member and the screw-like member from being detached from each other. In other words, it is possible to prevent the fitting state of the locking portion and the screw-like member from being released. Therefore, it is possible to prevent occurrence of a fault that it becomes impossible to transmit a driving force to the lens holder on which the connecting member is placed, that is, a fault that it becomes impossible to adjust spherical aberration, that is, correct spherical aberration.

Still further, in the invention, it is preferable that:

the detachment prevention portion includes a pair of locking portions placed so as to be opposite to each other; and

the pair of locking portions fit to the screw-like member while holding the screw-like member therebetween.

According to the invention, the pair of locking portions placed so as to be opposite to each other fit to the screw-like member while holding the screw-like member therebetween. Consequently, it is possible to prevent the locking portions from being detached from the screw-like member. In other words, it is possible to prevent the fitting state of the locking portions and the screw-like member from being released. Consequently, it is possible to prevent occurrence of a fault that it becomes impossible to transmit a driving force to the lens holder on which the connecting member is placed, namely, a fault that it becomes impossible to adjust spherical aberration, that is, to correct spherical aberration.

Still further, in the invention, it is preferable that the detachment prevention portion includes a surrounding portion formed so as to be connected to the locking portion, extend to a position opposite to the locking portion, and surround the screw-like member.

According to the invention, the detachment prevention portion is formed so as to include the surrounding portion formed so as to be connected to the locking portion, extend to a position opposite to the locking portion, and surround the screw-like member. Consequently, it is possible to securely prevent the locking portion from being detached from the screw-like member. As a result, it is possible to securely prevent occurrence of a fault that it becomes impossible to transmit a driving force to the lens holder on which the connecting member is placed, namely, a fault that it becomes impossible to adjust spherical aberration, that is, to correct spherical aberration.

Still further, in the invention, it is preferable that the first lens holder is provided with a position sensor which detects the relative position to the second lens holder, and the second lens holder is provided with a detected portion which can be detected by the position sensor.

According to the invention, the first lens holder is provided with the position sensor that detects the relative position to the second lens holder. The second lens holder is provided with the detected portion that can be detected by the position sensor. Therefore, it is possible to detect the relative position of the second lens holder to the first lens holder by detecting the position of the detected portion by using the position sensor. Consequently, it becomes possible to adjust spherical aberration, that is, to correct spherical aberration, for example, by detecting a starting position of the second lens holder and moving the second lens holder from the starting position.

Still further, in the invention, it is preferable that the detected portion is formed in one body with the connecting member.

According to the invention, the detected portion disposed to the second lens holder is formed in one body with the connecting member. Consequently, it is possible to decrease components count of an optical adjustment device, and it is possible to realize simplification and downsizing of an optical adjustment device.

Still further, the invention provides an optical pickup apparatus provided with the optical adjustment device mentioned above.

According to the invention, in the optical pickup apparatus provided with the optical adjustment device, the driving force of the driving source disposed to the optical adjustment device is transmitted to the second lens holder via the screw-like member and the connecting member. Consequently, the second lens holder can be displaced with respect to the first lens holder, so that it is possible to adjust the relative positions of the first lens holder and the second lens holder, and it is possible to realize an optical pickup apparatus in which it is possible to adjust the spherical aberration of an optical system, that is, to correct the spherical aberration.

Still further, the invention provides a method for assembling an optical adjustment device which comprises a first lens holder for holding a first lens, a second lens holder disposed so as to be freely displaced with respect to the first lens holder, for holding a second lens, a driving source, a screw-like member rotationally driven by the driving source, and a connecting member provided on one of the first and second lens holders and having a locking portion fitted to the screw-like member, and which optical adjustment device adjusts the spherical aberration of an optical system of an optical pickup apparatus by adjusting the relative positions of the first lens and the second lens, the method for assembling the optical adjustment device comprising:

a placing step of positioning and disposing the first and second lens holders, the driving source, and the screw-like member; and

a fixing step of fixing the connecting member to either the first or the second lens holder by disposing the connecting member across the either the first or the second lens holder and the screw-like member, and resiliently deforming the connecting member by applying to the connecting member a pressing force within a predetermined range in a direction in which the connecting member approaches the screw-like member.

According to the invention, in the placing step, the first and second lens holders, the driving source and the screw-like member are positioned and placed. In the fixing step, the connecting member is placed across one of the first and second lens holders and the screw-like member, a pressing force within a predetermined range in the direction approaching the screw-like member is applied to the connecting member to resiliently deform the connecting member and, in this state, the connecting member is fixed to one of the first and second lens holders.

By the placing step and the fixing step, it is possible to apply a pressing force within a predetermined range in the direction approaching the screw-like member to the connecting member, and fix the connecting member to one of the first and second lens holders in the resiliently deformed state. Consequently, the locking portion of the connecting member and the screw-like member can fit to each other in the state maintaining an abutting force within a predetermined range. Therefore, when the screw-like member is rotationally driven by the driving force of the driving source, and the connecting member is thereby displaced, it is possible to prevent the fitting of the screw-like member and the connecting member from being released by external shock or the like and dislocation from being caused. Moreover, it is possible to provide an optical adjustment device which makes it possible to prevent that because the abutting force of the screw-like member and the connecting member is too large, a frictional force is produced between the connecting member and screw-like member, and consequently, the respective members are damaged.

Still further, the invention provides an apparatus for assembling an optical adjustment device which comprises a first lens holder for holding a first lens, a second lens holder disposed so as to be freely displaced with respect to the first lens holder, for holding a second lens, a driving source, a screw-like member rotationally driven by the driving source, and a connecting member provided on one of the first and second lens holders and having a locking portion fitted to the screw-like member, and which optical adjustment device adjusts the spherical aberration of an optical system of an optical pickup apparatus by adjusting the relative positions of the first lens and the second lens, the apparatus for assembling the optical adjustment device comprising:

pressing means for applying a pressing force within a predetermined range in a direction where the connecting member approaches the screw-like member, to a precursor where the first and second lens holders, the driving source and the screw-like member are positioned and disposed and the connecting member is placed across one of the first and second lens holders and the screw-like member, thereby resiliently deforming the connecting member; and

fixing means for fixing the connecting member to one of the first and second lens holders.

According to the invention, the apparatus for assembling the optical adjustment device is provided with the pressing means that applies a pressing force within a predetermined range in the direction causing the connecting member to approach the screw-like member, to the precursor where the connecting member is placed across one of the first and second lens holders and the screw-like member, thereby resiliently deforming the connecting member, and the fixing means can fix the connecting member resiliently deformed by the pressing means, to one of the first and second lens holders in the resiliently deformed state. Consequently, it is possible to apply a predetermined pressing force in the direction approaching the screw-like member to the connecting member, thereby resiliently deforming the connecting member. Moreover, it is possible to maintain the abutting force of the connecting member and the screw-like member to be constant, and it is possible to provide an optical adjustment device that can maintain the fitting state of the connecting member and the screw-like member in a constant state.

### BRIEF DESCRIPTION OF THE DRAWINGS

Other and further objects, features, and advantages of the invention will be more explicit from the following detailed description taken with reference to the drawings wherein:

FIG. 1 is a perspective view showing an optical adjustment device according to a first embodiment of the invention;

FIG. 2 is an exploded perspective view showing the optical adjustment device;

FIG. 3 is a plan view showing the optical adjustment device;

FIG. 4 is a front view showing the optical adjustment device;

FIG. 5 is a simplified block diagram showing a configuration of an information recording and reproducing apparatus;

FIG. 6 is a flowchart showing a processing procedure of a control portion on adjustment of a position of a second lens holder;

FIG. 7 is a simplified front view showing an optical adjustment device according to a second embodiment of the invention;

FIG. 8 is an enlarged front view showing section IX of FIG. 7;

FIG. 9 is a simplified plan view showing the optical adjustment device shown in FIG. 7;

FIG. 10 is a simplified plan view showing an optical adjustment device according to a third embodiment of the invention;

FIG. 11 is a plan view showing the optical adjustment device when a clearance is created between a first lens holder and a second lens holder;

FIG. 12 is a simplified plan view showing an optical adjustment device according to a fourth embodiment of the invention;

FIG. 13 is a simplified front view showing the optical adjustment device;

FIG. 14 is a simplified front view showing an optical adjustment device according to a fifth embodiment of the invention;

FIG. 15 is a simplified front view of an optical adjustment device according to a sixth embodiment of the invention;

FIG. 16 is a simplified front view showing an optical adjustment device according to a seventh embodiment of the invention;

FIG. 17 is a simplified front view showing an optical adjustment device according to an eighth embodiment of the invention;

FIG. 18 is a simplified view showing a configuration of an optical pickup apparatus;

FIG. 19 is a front view showing an assembly apparatus that assembles the optical adjustment device, and the optical adjustment device placed on the assembly apparatus;

FIG. 20 is a front view showing an assembly apparatus and the optical adjustment device, in which the assembly apparatus for assembling the optical adjustment device is in a state where a pressure force within a predetermined range is applied to a grip rack of the optical adjustment device placed on the assembly apparatus;

FIG. 21 is a flowchart showing the procedure of a method for assembling the optical adjustment device;

FIG. 22 is a magnified front view showing a part where a micrometer head abuts against the grip rack in the apparatus for assembling the optical adjustment device shown in FIG. 20;

FIG. 23 is a view showing an optical layout of a related art optical pickup apparatus;

FIG. 24 is a simplified perspective view showing the related art optical pickup apparatus;

FIG. 25 is a perspective view showing a first related art optical adjustment device;

FIG. 26 is an exploded perspective view showing the optical adjustment device;

FIG. 27 is a plan view showing the optical adjustment device; and

FIG. 28 is a front view showing the optical adjustment device.

### DETAILED DESCRIPTION

Now referring to the drawings, preferred embodiments of the invention are described below.

A plurality of embodiments of the invention will be described below. In the respective embodiments, parts corresponding to those described in a previous embodiment are denoted by the same reference numerals, and duplication of a description may be omitted. In a case where only part of a configuration is described, the rest of the configuration is considered to be the same as in a previously described embodiment.

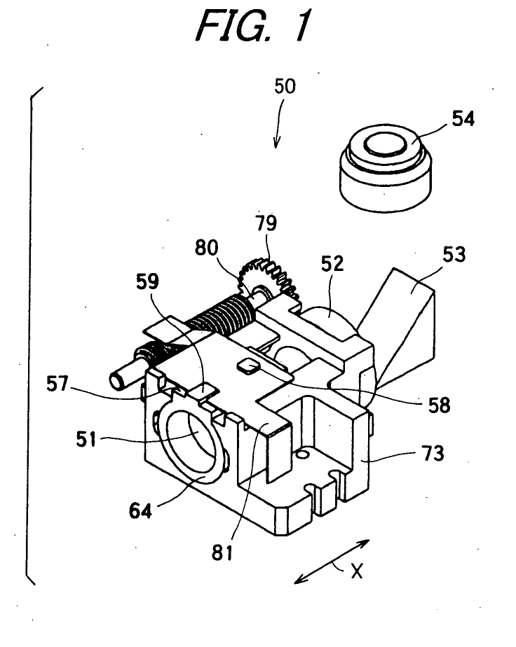

FIG. 1 is a perspective view showing an optical adjustment device 50 according to a first embodiment of the invention. The optical adjustment device 50 is a device that adjusts spherical aberration caused by an error in thickness of an optical disk. The optical adjustment device 50 is disposed at a midway portion of a light path between a semiconductor laser device serving as a light source and an objective lens 54 that condenses light via a raising mirror 53. The optical adjustment device 50 has a concave lens 51 that is a second lens, a convex lens 52 that is a first lens formed in pairs (simply referred to as “convex lens” hereinafter), a second lens holder 64 that holds the concave lens 51, a first lens holder 73 that holds the convex lens 52, a feed screw member 80 serving as the screw-like member, a fourth reduction gear 79 that engages with the feed screw member 80, and a grip rack 81 serving as the connecting member.

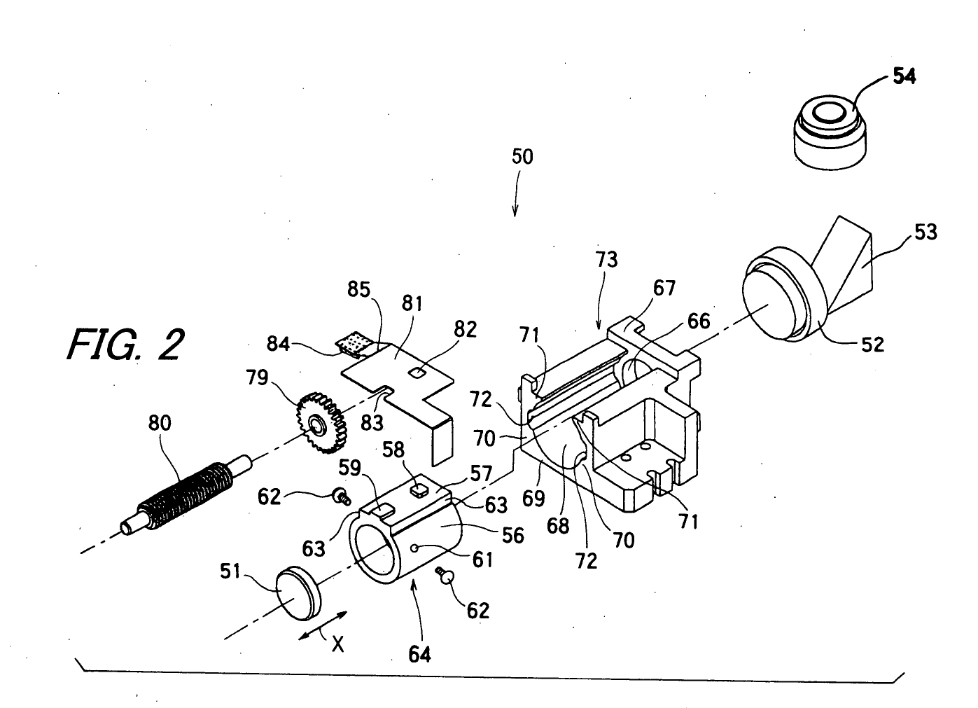

FIG. 2 is an exploded perspective view showing the optical adjustment device 50. The first lens holder 73 has a holding portion 67 that holds the convex lens 52. The holding portion 67 is plate-shaped. On the holding portion 67, a hole 66 that passes through in the thickness direction is formed. Further, the convex lens 52 fits into the hole 66. A guiding portion 68 is formed so as to extend from the holding portion 67 along the axis of the convex lens 52. The guiding portion 68 has a cross section perpendicular to the axis, and the cross section is formed so as to be substantially C-shaped uniformly. Moreover, the holding portion 67 and the guiding portion 68 are formed so that the axis of the hole 66 formed on the holding portion 67 and the axis of the guiding portion 68 coincide.

The guiding portion 68 has a base portion 69, raised portions 70 formed so as to rise from both ends of the base portion 69, and projecting portions 71 that protrude from the tips of the raised portions 70 in a direction approaching each other. Moreover, the inner periphery of the guiding portion 68 is formed into a substantially cylindrical shape, and a space therein is formed so as to be open to the outside via between the projecting portions 71. The projecting portions 71 are formed so that the distance therebetween is smaller than the diameter of the guiding portion 68. Moreover, on each of the raised portions 70, a depressed groove 72 is formed extending uniformly in parallel to the axis of the guiding portion 68.

The second lens holder 64 has one convex portion 57 protruding outward, in the circumferential direction of a cylindrical main body 56 thereof. The concave lens 51 fits into the main body 56, and the concave lens 51 is fixed by engagement of a screw member 62 or the like into a screw hole 61. The second lens holder 64 is formed so as to extend in parallel to the axis of the concave lens 51 fitting into the main body 56. Also, the convex portion 57 is formed so as to extend in the axial direction along the main body 56. The convex portion 57 is provided with a first top-face projection 58 and a second top-face projection 59 that project from the convex portion 57.

The main body 56 of the second lens holder 64 is designed so that the outer diameter is slightly smaller than the inner diameter of the guiding portion 68 of the first lens holder 73. The main body 56 of the second lens holder 64 fits into the guiding portion 68 of the first lens holder 73. Moreover, the convex portion 57 fits into between the projecting portions 71 of the first lens holder 73, and the main body 56 is guided along the axis by the guiding portion 68 in a state where displacement in a direction perpendicular to the axis is inhibited. Furthermore, the convex portion 57 fits into between the projecting portions 71 of the guiding portion 68, and both circumferential ends 63 of the convex portion 57 are supported by between the projecting portions 71 of the guiding portion 68, whereby the convex portion is guided in the axial direction in a state where rotation around the axis is inhibited.

Besides, the main body 56 of the second lens holder 64 is formed so that the length in the axial direction becomes shorter than the length in the axial direction of the guiding portion 68 of the first lens holder 73. Therefore, in the state fitting into the guiding portion 68 of the first lens holder 73, the second lens holder 63 can be displaced in an approaching direction of causing the concave lens 51 to approach the convex lens 52 and a leaving direction of causing the concave lens 51 to leave the convex lens 52 (may be simply referred to as “approaching and leaving direction X” hereinafter). Since the second lens holder 64 is thus guided along the first lens holder 73, it is possible to realize the optical adjustment device 50 that makes it possible to adjust the relative positions of the concave lens 51 and the convex lens 52.

The grip rack 81 is provided with a rack hole 82 into which the first top-face projection 58 of the second lens holder 64 is inserted, and a notch 83 into which the second top-face projection 59 of the second lens holder 64 is inserted. Moreover, the grip rack 81 has a locking portion 84 that fits to the feed screw member 80. Furthermore, the grip rack 81 is formed so as to have a mountain-shaped portion 85 that is curved like a mountain and that resiliently abuts against the feed screw member. Because the grip rack 81 has the mountain-shaped portion 85, the grip rack 81 is resiliently deformed when a pressing force is applied to the grip rack 81 in a direction approaching the feed screw member 80. The grip rack 81 is manufactured using a mold in consideration of mass productivity.

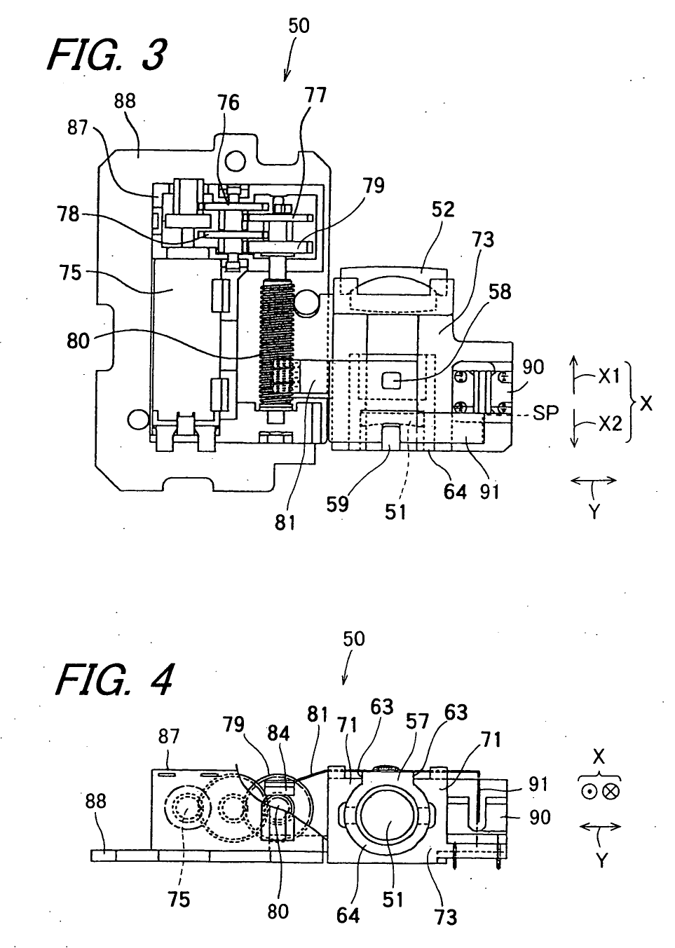

FIG. 3 is a plan view showing the optical adjustment device 50. FIG. 4 is a front view showing the optical adjustment device 50. In FIG. 4, a gear storage table 87 placed on a base 88 is shown in a manner that part thereof on the side of the first lens holder 73 is omitted. In the present embodiment, a direction perpendicular to both the approaching and leaving direction X and the thickness direction of the first lens holder 73 is defined as a “Y-axis direction.” In FIGS. 3 and 4, the Y-axis direction is represented with “Y.”

The optical adjustment device 50 further has a driving source 75 that drives the second lens holder 64, and a first, second, third and fourth reduction gears 76, 77, 78 and 79 that transmit the driving force of the driving source 75 to the feed screw member 80. The first to fourth reduction gears 76 to 79, the feed screw member 80, and the driving source 75 are built into the gear storage table 87. Further, the gear storage table 87 and the first lens holder 73 are placed on the base 88.

The driving force of the driving source 75 formed by, for example, an electric motor is transmitted to the feed screw member 80 via the first to fourth reduction gears 76 to 79, and the feed screw member 80 is rotated, whereby the grip rack 81 that fits to the feed screw member 80 is displaced in the approaching and leaving direction X, which is the approaching direction and the leaving direction. Since the rack hole 82 and the notch 83 of the grip rack 81 are disposed so that the first top-face projection 58 and the second top-face projection 59 of the second lens holder 64 fit thereinto, a force for displacement in the approaching and leaving direction X is applied to the first top-face projection 58 and the second top-face projection 59 of the second lens holder 64 when the grip rack 81 is displaced in the approaching and leaving direction X. Consequently, the second lens holder 64 is displaced in the approaching and leaving direction X along the guiding portion 68 of the first lens holder 73. Accordingly, in the optical adjustment device 50, when spherical aberration is caused, it is possible to displace the second lens holder 64 that holds the concave lens 51 in the approaching and leaving direction X, thereby adjusting the relative position to the first lens holder 73, and adjusting the spherical aberration, that is, correct the spherical aberration.

As described before, according to the invention, the second lens holder 64 on which the convex portion 57 protruding outward is formed in the circumferential direction is disposed so as to fit into the substantially C-shaped guiding portion 68 of the first lens holder 73, and both the circumferential ends 63 of the convex portion 57 of the second lens holder 64 are guided by both circumferential ends of the guiding portion 68 of the first lens holder 73. Moreover, the grip rack 81 is disposed to one of the first and second lens holders 73 and 64, in the present embodiment, to the second lens holder 64, and furthermore, the locking portion 84 disposed to the grip rack 81 is provided so as to fit to the feed screw member 80.

Consequently, the driving force of the driving source 75 can be transmitted to the grip rack 81 via the feed screw member 80, and by displacement of the grip rack 81, one of the first and second lens holders 73 and 64, in the present embodiment, the second lens holder 64 can be displaced, and the second lens holder 64 can be displaced along the substantially C-shaped guiding portion 68 of the first lens holder 73. Therefore, it is possible to displace the second lens holder 64 with respect to the first lens holder 73 without the need for a plurality of guides, it is possible to realize the optical adjustment device 50 in a simple configuration, and it is possible to adjust the spherical aberration of an optical system of an optical pickup apparatus, that is, correct the spherical aberration. Moreover, it is possible to realize simplification and downsizing of the optical adjustment device 50.

Further, according to the present embodiment, the grip rack 81 has the mountain-shaped portion 85, so that the grip rack 81 can be resiliently deformed and abut against the feed screw member 80 when a pressing force in a direction approaching the feed screw member 80 is given to the grip rack. Consequently, it is possible to fit the locking portion 84 of the grip rack 81 to the feed screw member 80. Therefore, in a case where the feed screw member 80 is rotationally driven by the driving force of the driving source 75 and the grip rack 81 is displaced, the grip rack 81 can be displaced as the feed screw member 80 rotates. Accordingly, it is possible to prevent the fitting state of the feed screw member 80 and the grip rack 81 from being released by external shock or the like and dislocation from being caused.

Further, it is possible to prevent frictional force from being produced between the grip rack 81 and the feed screw member 80 and the respective members from being damaged, and it is possible to realize the highly reliable optical adjustment device 50. In other words, it is possible to make a load at the time of movement of the grip rack 81 constant, and it is possible to avoid a fault in operation caused by increase and decrease of the load.

Further, the driving force of the driving source 75 is transmitted to the grip rack 81 via the feed screw member 80, the grip rack 81 can be displaced as the feed screw member 80 rotates, and it is possible to displace the second lens holder 64 relatively to the first lens holder 73 and adjust, that is, correct the spherical aberration of an optical system of an optical pickup apparatus.

Next, adjustment of the position of the second lens holder 64 at the time of adjustment of spherical aberration will be described. The optical adjustment device 50 further has a photointerrupter 90 and a shield 91. The photointerrupter 90 is a photosensor that has a light-emitting portion and a light-receiving portion. The photointerrupter 90 is disposed to one end in the Y-axis direction of the first lens holder 73. The shield 91 is a detected portion that can be detected by the photointerrupter 90, and disposed to the second lens holder 64. The shield 91 is spaced from the photointerrupter 90 in the Y-axis direction. The shield 91 of the present embodiment is formed in one body with the grip rack 81. The photointerrupter 90 is a light-reflective photointerrupter, and includes the light-emitting portion formed by a light-emitting diode (abbreviated to LED) and the light-receiving portion formed by a photodiode.

The photointerrupter 90 emits light from the light-emitting portion, and receives light reflected by the shield 91 disposed to the second lens holder 64 or by the first lens holder 73, at the light-receiving portion. The light-receiving portion detects electric signals based on the received light. The photointerrupter 90 functions as a position sensor that detects the relative position of the first lens holder 73 to the second lens holder 64 based on the electric signals detected by the light-receiving portion.

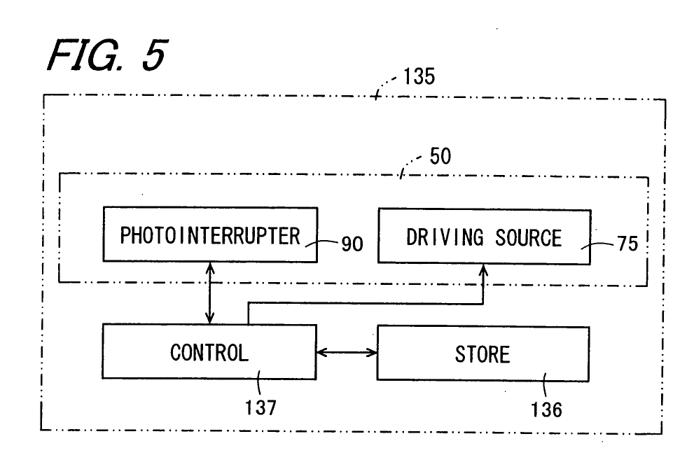

FIG. 5 is a simplified block diagram showing the configuration of an information recording and reproducing apparatus 135. The information recording and reproducing apparatus 135 comprises the optical adjustment device 50, a storing portion 136, and a control portion 137. The optical adjustment device 50 comprises the photointerrupter 90 and the driving source 75. The storing portion 136 stores a control program for adjusting spherical aberration. The control portion 136 controls the optical adjustment device 50 so as to displace the relative position of the second lens holder 64 to the first lens holder 73 and adjust the spherical aberration of an optical system in accordance with the control program stored in the storing portion 136.

The photointerrupter 90 gives the electric signals detected by the light-receiving portion to the control portion 137. The control portion 137 grasps the relative position of the second lens holder 64 to the first lens holder 73 based on the electric signals given from the photointerrupter 90, and calculates such a relative position of the second lens holder 64 to the first lens holder 73 that the spherical aberration becomes the minimum. The control portion 137 gives electric signals for causing the second lens holder 64 to move to the calculated relative position, to the driving source 75 of the optical adjustment device 50.

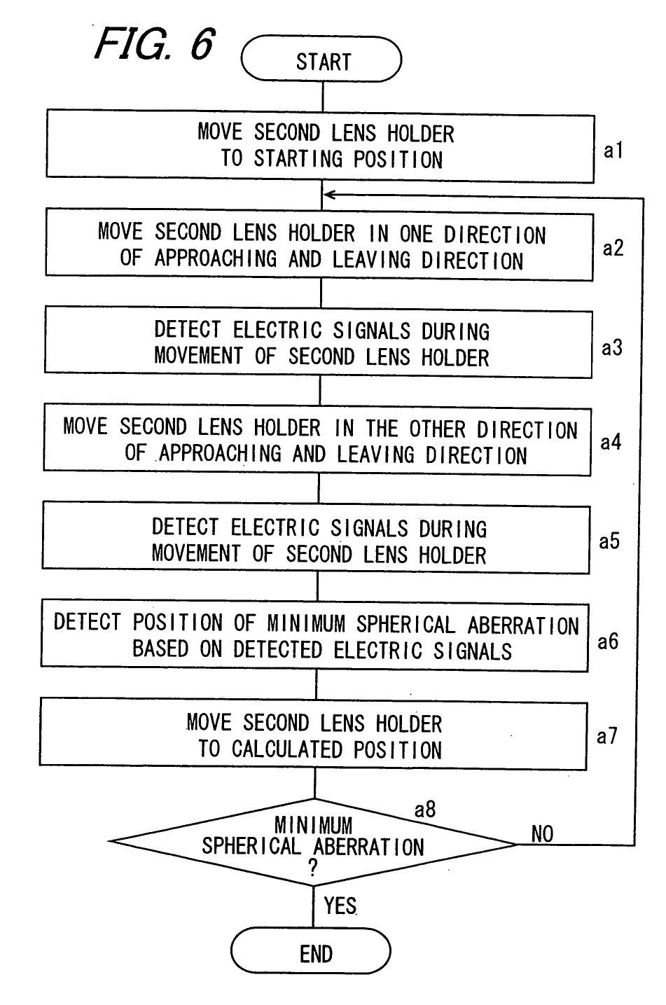

FIG. 6 is a flowchart showing the processing procedure of the control portion 137 on adjustment of the position of the second lens holder 64. The present processing is repeatedly executed when the information recording and reproducing apparatus 135 provided with the optical adjustment device 50 is turned on or when an optical disk is replaced. The present processing is executed by the control portion 137.

At step a1, based on electric signals given from the light-receiving portion of the photointerrupter 90, a signal that represents a command for causing the second lens holder 64 to move to a starting position SP corresponding to a position in which the output of the electric signals changes (simply referred to as “starting movement command signal” hereinafter) is given to the driving source 75 of the optical adjustment device 50. Consequently, the driving source 75 transmits a driving force to the feed screw member 80 in accordance with the starting movement command signal given from the control portion 137. Consequently, the feed screw member 80 rotates, and the grip rack 81 fitting to the feed screw member 80 is displaced in the approaching and leaving direction X. Consequently, the second lens holder 64 on which the grip rack 81 is mounted is displaced in the approaching and leaving direction X along the guiding portion 68 of the first lens holder 73, and moved to the starting position SP. After the second lens holder 64 is moved to the starting position SP, the procedure advances to step a2.

At step a2, the second lens holder 64 gives the driving source 75 a signal that represents a command for causing the second lens holder 64 to move in one direction X1 of the approaching and leaving direction, that is, causing the second lens holder 64 to move in a direction approaching the first lens holder 73 (simply referred to as “approaching movement command signal” hereinafter). The driving source 75 transmits a driving force to the feed screw member 80 in accordance with the approaching movement command signal given from the control portion 137. Consequently, the second lens holder 64 is caused to move in the one direction X1 of the approaching and leaving direction. After the second lens holder 64 is moved in the one direction X1 of the approaching and leaving direction, the procedure advances to step a3.

At step a3, a signal that represents a command to detect electric signals while the second lens holder 64 moves in the one direction X1 of the approaching and leaving direction and returns to the starting position SP (simply referred to as “approaching signal detection command signal” hereinafter) is given to the photointerrupter 90. In accordance with the approaching signal detection command signal given from the control portion 137, the photointerrupter 90 emits light from the light-emitting portion, and receives reflective light and detects electric signals at the light-receiving portion. The electric signals detected at the light-receiving portion are temporarily stored in the storing portion 136 via the control portion 137. After the second lens holder 64 returns to the starting position SP, the procedure advances to step a4.

At step a4, a signal that represents a command to cause the second lens holder 64 to move in the other direction X2 of the approaching and leaving direction, that is, in a direction leaving the first lens holder 73 (simply referred to as “leaving movement command signal” hereinafter) is given to the driving source 75. The driving source 75 transmits a driving force to the feed screw member 80 in accordance with the leaving movement command signal given from the control portion 137. Consequently, the second lens holder 64 is caused to move in the other direction X2 of the approaching and leaving direction. After the second lens holder 64 is moved in the other direction X2 of the approaching and leaving direction, the procedure advances to step a5.

At step a5, a signal that represents a command to detect electric signals while the second lens holder 64 moves in the other direction X2 of the approaching and leaving direction and returns to the starting position SP (simply referred to as “leaving signal detection command signal” hereinafter) is given to the photointerrupter 90. In accordance with the leaving signal detection command signal given from the control portion 137, the photointerrupter 90 emits light from the light-emitting portion, and receives reflective light and detects electric signals at the light-receiving portion. The electric signals detected at the light-receiving portion are temporarily stored in the storing portion 136 via the control portion 137. After the second lens holder 64 returns to the starting position SP, the procedure advances to step a6.

At step a6, the electric signals temporarily stored in the storing portion 136 are read out, and based on the electric signals having been read out, such a position of the second lens holder 64 that spherical aberration becomes the minimum is calculated. After such a position of the second lens holder 64 that spherical aberration becomes the minimum is calculated, the procedure advances to step a7.

At step a7, a signal that represents a command for causing the second lens holder 64 to move to the calculated position in which spherical aberration becomes the minimum (simply referred to as “movement command signal” hereinafter) is given to the driving source 75. The driving source 75 transmits a driving force to the feed screw member 80 in accordance with the movement command signal given from the control portion 137. Consequently, the second lens holder 64 is caused to move to the position in which spherical aberration becomes the minimum. After the second lens holder 64 is moved to the position in which spherical aberration becomes the minimum, the procedure advances to step a8.

At step a8, it is determined whether spherical aberration is the minimum or not, and the present processing is ended when the spherical aberration is the minimum, whereas the procedure returns to step a2 and the same processing as described above is repeatedly executed when the spherical aberration is not the minimum.

As described before, according to the present embodiment, by detecting the position of the shield 91 by using the photointerrupter 90, it is possible to detect the relative position of the second lens holder 64 to the first lens holder 73. Consequently, for example, by detecting the starting position SP of the second lens holder 64 and moving the second lens holder 64 from the starting position SP in the approaching and leaving direction X, it is possible to adjust spherical aberration so as to become the minimum, that is, correct spherical aberration so as to become the minimum.

Further, by forming the shield 91 disposed to the second lens holder 64 in one body with the grip rack 81, it is possible to reduce components count of the optical adjustment device 50, and it is possible to realize simplification and downsizing of the optical adjustment device 50.

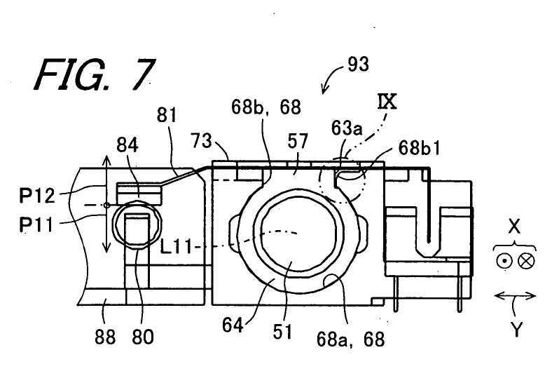

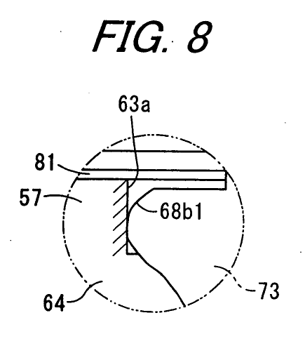

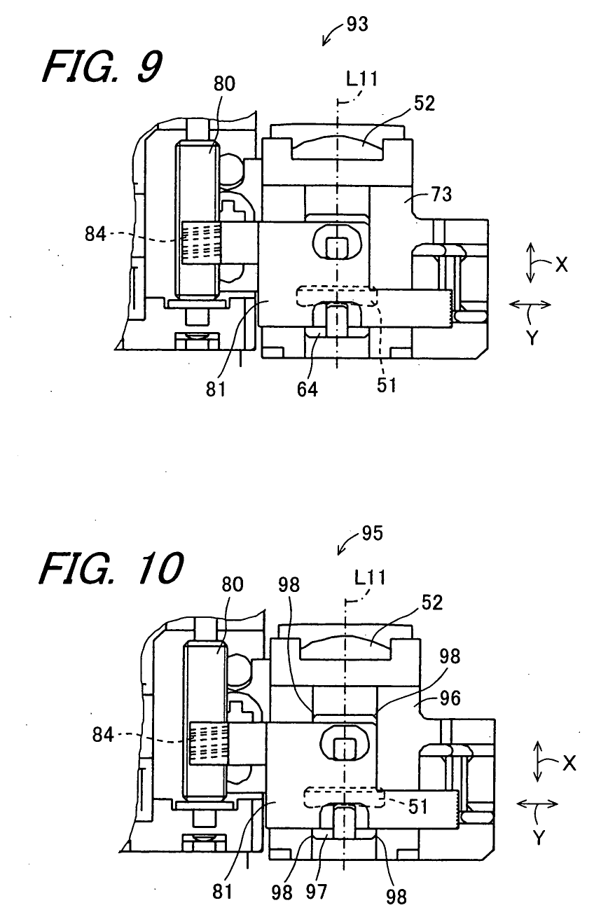

FIG. 7 is a simplified front view showing an optical adjustment device 93 according to a second embodiment of the invention. FIG. 8 is an enlarged front view showing section IX of FIG. 7. FIG. 9 is a simplified plan view showing the optical adjustment device 93 shown in FIG. 7. Since the optical adjustment device 93 of the present embodiment is similar in configuration to the optical adjustment device 50 of the first embodiment, the same components are denoted by the same reference numerals, and the descriptions thereof are omitted. In the following embodiment, a direction perpendicular to both the approaching and leaving direction X and the thickness direction of the first lens holder 73 is defined as a “Y-axis direction.” Moreover, in the figures showing the optical adjustment device of the following embodiment, the Y-axis direction is represented with “Y.”

The optical adjustment device 93 has the concave lens 51, the convex lens 52, the second lens holder 64 that holds the concave lens 51, the first lens holder 73 that holds the convex lens 52, a driving source which is not shown in the figures, the feed screw member 80 corresponding to the screw-like member that is rotationally driven when the driving force of the driving source is transmitted thereto, the fourth reduction gear 79 that engages with the feed screw member 80, and the grip rack 81 serving as the connecting member. On the grip rack 81, the locking portion 84 is formed so as to be placed on the second lens holder 64 and fit to the feed screw member 80. The optical adjustment device 93 is used in the case of adjusting the relative positions of the second lens holder 64 holding the concave lens 51 and the first lens holder 73 holding the convex lens 52, thereby adjusting, that is, correcting the spherical aberration of an optical system.

The feed screw member 80 is, for example, an external screw member. The feed screw member 80 is rotatably supported on the base 88 of the optical adjustment device 93 so that the axis becomes parallel to an optical axis L11 of the concave lens 51 and the convex lens 52, and rotationally driven when a driving force is transmitted thereto from the driving source.

The locking portion 84 is an internal screw member to which an internal screw is carved so as to match and fit to the feed screw member 80 that is the external screw member. When the feed screw member 80 that is the external screw member is rotationally driven, the locking portion 84 fitting to the feed screw member 80 is thereby linearly driven in a direction parallel to the approaching and leaving direction X. When the locking portion 84 is linearly driven in a direction parallel to the approaching and leaving direction X, the grip rack 81 provided with the locking portion 84, the second lens holder 64 on which the grip rack 81 is mounted, and the concave lens 51 placed on the second lens holder 64 can thereby move in the approaching and leaving direction X.

The first lens holder 73 is formed so as to be substantially C-shaped in cross section perpendicular to the optical axis L11, that is, in cross section perpendicular to the approaching and leaving direction X. An interior wall portion 68a and an opening portion 68b that form the interior space of the first lens holder 73 compose the guiding portion 68 that guides the second lens holder 64. The second lens holder 64 is formed so as to be substantially circular in cross section perpendicular to the optical axis L11, that is, in cross section perpendicular to the approaching and leaving direction X, and is provided with the convex portion 57 that protrudes outward in the radial direction, at part in the circumference direction.

The second lens holder 64 is configured so that the second lens holder fits into the guiding portion 68 of the first lens holder 73, in specific, the convex portion 57 fits into the opening portion 68b of the first lens holder 73, and so that the second lens holder can be guided and moved in the guiding portion 68. As described before, the grip rack 81 is mounted on the second lens holder 64, and the grip rack 81 can be driven in the approaching and leaving direction X by a driving force transmitted via the feed screw member 80 and the locking portion 84, so that the second lens holder 64 can move in the approaching and leaving direction X.

In the present embodiment, the position of the first lens holder 73 holding the convex lens 52 is fixed, and the second lens holder 64 holding the concave lens 51 is configured so as to be movable in the approaching and leaving direction X. Therefore, in the optical adjustment device 93, it is possible to displace the relative position of the second lens holder 64 to the first lens holder 73, thereby adjusting the relative positions of the concave lens 51 and the convex lens 52, and adjusting spherical aberration, that is, correcting spherical aberration.

At the time of displacement of the relative position of the second lens holder 64 to the first lens holder 73, the outer periphery and the convex portion 57 of the second lens holder 64 slide on the guiding portion 68 of the first lens holder 73, whereby a sliding load is produced. In the optical adjustment device 93 of the present embodiment, as shown in FIG. 7, the locking portion 84 of the grip rack 81 is disposed so as to fit to the feed screw member 80 while applying constant pressure P11 thereon.

Therefore, a reaction force P12 to the pressure P11 acts in exactly the opposite direction to a direction in which the pressure P11 acts, and the reaction force P12 acts in the clockwise direction about the optical axis L11 especially on the second lens holder 64. Consequently, a sliding load tends to get large at a sliding portion where, of both the circumferential ends 63 of the convex portion 57 of the second lens holder 64, the circumferential end 63 farther from the locking portion 84, namely, the circumferential end on one side of the Y-axis direction (simply referred to as “one circumferential end 63a” hereinafter) slides on an opening portion 68b1 of the first lens holder 73, as compared with at the other sliding portions. Although the opening portion forming the interior space of the first lens holder 73 is denoted by reference numeral “68b” as described before, the opening portion of the first lens holder 73 on which the one circumferential end 63a slides is denoted by reference numeral “68b1” in specific.

In FIG. 8, the sliding portion where the one circumferential end 63a slides on the opening portion 68b1 of the first lens holder 73 abutting against the one circumferential end 63a and where a sliding load is large as compared with at the other sliding portions, is shown by hatching. In the optical adjustment device 93 of the present embodiment, the opening portion 68b1 that is a sliding portion on the side of the first lens holder 73 abutting against the one circumferential end 63a of the second lens holder 64 is formed into a shape having curvature, that is, formed so as to be rounded. In other words, the opening portion 68b1 is formed into a curved shape that protrudes in the other direction of the Y-axis direction, that is, protrudes toward the circumferential end on the other side of the Y-axis direction of both the circumferential ends 63 of the convex portion 57, which is the circumferential end closer to the locking portion 84 (simply referred to as “the other circumferential end” hereinafter).

By thus rounding the opening portion 68b1 of the first lens holder 73, that is, forming the opening portion 68b1 into a curved shape, it is possible to considerably reduce a sliding load at the sliding portion of the one circumferential end 63a and the opening portion 68b1 where a sliding load tends to get larger by nature. In other words, by decreasing the abutting area of the one circumferential end 63a and the opening portion 68b1 to decrease sliding friction, and also eliminating an angular portion from the opening portion 68b1, it is possible to prevent the one circumferential end 63a from being damaged, and it is possible to prevent the opening portion 68b1 from cutting into the one circumferential end 63a. Consequently, it is possible to reduce resistance when the one circumferential end 63a slides on the opening portion 68b1, and it is possible to realize smooth sliding.

By reducing a sliding load on adjustment of the relative positions of the first lens holder 73 and the second lens holder 64, it is possible to increase the accuracy of positioning, so that it is possible to adjust spherical aberration with high accuracy, that is, correct spherical aberration with high accuracy. In concrete, it is possible to correct spherical aberration so as to become the minimum.

Although the present embodiment describes such a configuration that the opening portion 68b1 that is a sliding portion on the side of the first lend holder 73 abutting against the one circumferential end 63a of the second lens holder 64 is formed into a curved shape protruding to the other side in the Y-axis direction, that is, protruding toward the other circumferential end, the configuration will not be limited to the above one. In another embodiment of the invention, the opening portion 68b that is a sliding portion on the side of the first lend holder 73 abutting against the other circumferential end of the second lens holder 64 may be formed into a curved shape protruding to the one side in the Y-axis direction, that is, protruding toward the one circumferential end 63a. Also in this configuration, it is possible to obtain the same effect as in the second embodiment.

Further, it is also possible to configure so that an opening portion that is a sliding portion on the side of the first lens holder 73 abutting against the one circumferential end 63a is formed into a curved shape protruding to the other side in the Y-axis direction and an opening portion that is a sliding portion on the side of the first lens holder 73 abutting against the other circumferential end is formed into a curved shape protruding to the one side in the Y-axis direction. Since it is possible to make sliding friction at the sliding portion of both the circumferential ends 63 and the Opening portion 68b of the first lens holder 73 small in this configuration, it is possible to further reduce a sliding load, and it is possible to realize smoother sliding.

FIG. 10 is a simplified plan view showing an optical adjustment device 95 according to a third embodiment of the invention. Since the optical adjustment device 95 of the present embodiment is similar in configuration to the optical adjustment device 93 of the second embodiment, the same components are denoted by the same reference numerals, and the descriptions thereof are omitted.

A second lens holder 97 that holds the concave lens 51 is formed into a substantially circular shape in cross section perpendicular to the optical axis L11, that is, in cross section perpendicular to the approaching and leaving direction X, and provided with a convex portion that protrudes outward in the radial direction, at part in the circumference direction. Moreover, the appearance of the entire second lens holder 97 is formed into a roughly cylindrical shape.

With regard to a first lens holder 96 and the second lens holder 97, the outer periphery and the convex portion of the second lens holder 97 slide on the guiding portion of the first lens holder 96, and a sliding load is thereby produced. In the second lens holder 97, a sliding portion that is likely to damage the guiding portion of the first lens holder 96 and cut into the guiding portion to increase a sliding load is a corner portion 98 formed by the bottom face and the side face of the second lens holder 97 formed into a cylindrical shape. In the optical adjustment device 95 of the present embodiment, the corner portion 98 of the second lens holder 97 is formed into a shape having curvature, that is, formed so as to be rounded.

In other words, in the second lens holder 97, of a sliding portion which is caused to slide on the first lens holder 96 and is a portion which does not include both the circumferential ends, portions formed by one and the other ends in the displacement direction of displacement with respect to the first lens holder 96 and outer circumferential edges on the outer circumferential side in the radial direction of one and the other end face portions of the second lens holder 97 forming virtual planes orthogonal to the displacement direction, are formed into curved shapes. The side face of the second lens holder 97 corresponds to the one and the other ends in the displacement direction, and the bottom face of the second lens holder 97 corresponds to the one and the other end face portions of the second lens holder 97. Moreover, the displacement direction corresponds to the approaching and leaving direction X.

There is a case where a clearance is created between the first lens holder 96 and the second lens holder 97 at the time of assembly because of a variation in the dimension tolerance on formation at the time of production. FIG. 11 is a plan view showing the optical adjustment device 95 when a clearance is created between the first lens holder 96 and the second lens holder 97. FIG. 11 schematically shows the clearance slightly exaggerated.

In a case where there is a clearance between the first lens holder 96 and the second lens holder 97, the second lens holder 97 cannot smoothly move in a direction parallel to the optical axis L11, that is, in the approaching and leaving direction X, and moves while forming a slight inclination angle α to the optical axis L11. Therefore, when the second lens holder 97 is caused to slide in order to adjust the relative positions of the first lens holder 96 and the second lens holder 97, the second lens holder 97 moves while swinging with respect to the optical axis L11, that is, moves in the rattling state.

When the second lens holder 97 is caused to slide on the guiding portion 68 of the first lens holder 96 in the rattling state, the corner portion 98 damages the guiding portion 68 or cuts into the guiding portion 68, in a case where the corner portion 98 of the second lens holder 97 has an angular portion. Then, in the present embodiment, the corner portion 98 of the second lens holder 97 is formed into a shape having curvature as described before.

Consequently, when adjusting the relative position of the second lens holder 97 to the first lens holder 96, that is, when causing the second lens holder 97 to slide on the guiding portion 68 of the first lens holder 96, it is possible to prevent the corner portion 98 of the second lens holder 97 from damaging the guiding portion 68 of the first lens holder 96 or cutting into the guiding portion 68, and it is possible to reduce a sliding load. Consequently, it is possible to position the first lens holder 96 and the second lens holder 97 with high accuracy, and it is possible to adjust spherical aberration with high accuracy, that is, correct spherical aberration with high accuracy. In concrete, it is possible to correct spherical aberration so as to become the minimum.

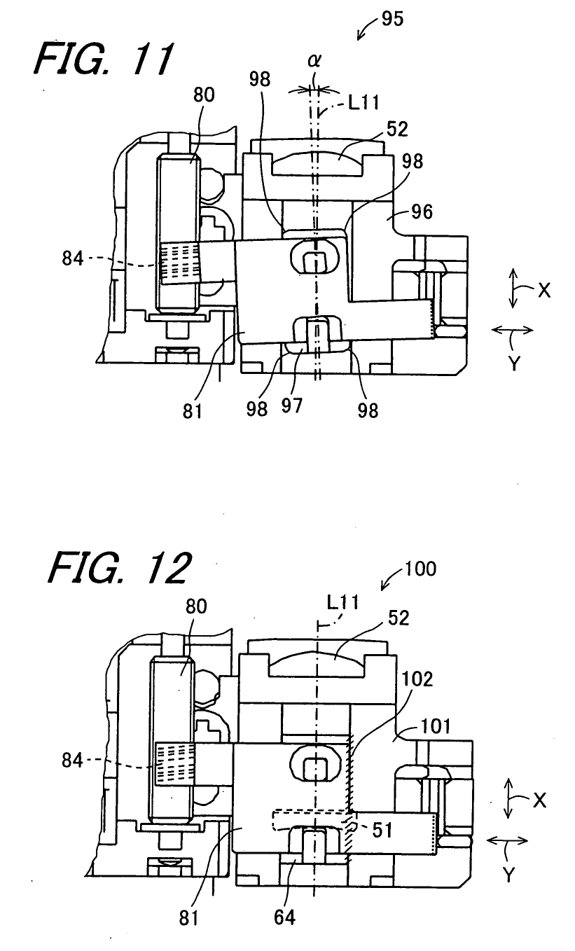

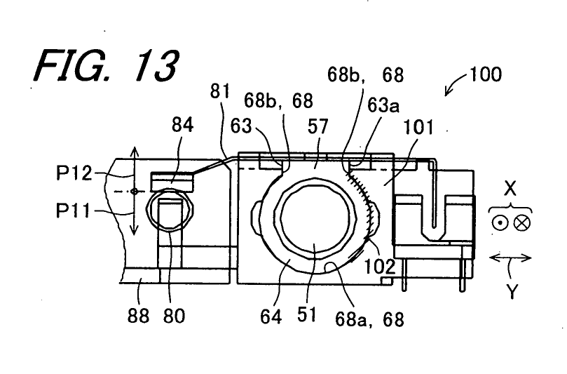

FIG. 12 is a simplified plan view showing an optical adjustment device 100 according to a fourth embodiment of the invention. FIG. 13 is a simplified front view showing the optical adjustment device 100. Since the optical adjustment device 100 of the present embodiment is similar in configuration to the optical adjustment device 93 of the second embodiment, the same components are denoted by the same reference numerals, and the descriptions thereof are omitted.

Since the grip rack 81 placed on the second lens holder 64 is disposed so that the locking portion 84 fits to the feed screw member 80 while applying the constant pressure P11 thereon, the reaction force P12 to the pressure P11 acts in exactly the opposite direction to a direction in which the pressure P11 acts. The reaction force P12 acts on the second lens holder 64 on which the grip rack 81 is placed, and causes the convex portion 57 of the second lens holder 64 to press against the opening portion 68b of the first lens holder 101.

In the present embodiment, a lubricant is applied to a sliding portion where a sliding load is large due to the reaction force P12 acting on the grip rack 81, which is a sliding portion 102 formed by: the outer periphery of the second lens holder 64 and the one circumferential end 63a located on the opposite side to a side facing the locking portion 84; and a portion on the one side in the Y-axis direction in the guiding portion 68 of the first lens holder 101, that is, a portion located on the farther side from the locking portion 84 in the guiding portion 68 of the first lens holder 101. In FIGS. 12 and 13, the sliding portion 102 is shown by hatching.

Although a lubricant is not limited in specific, a lubricant of liquid state having a low viscosity (semi-wet state), for example, a fluorinated lubricant is favorably used. By using a lubricant having a low viscosity, it becomes possible to sufficiently apply a lubricant to a gap between the first lens holder 101 and the second lens holder 64 by utilizing capillary phenomenon.

As described above, according to the present embodiment, by applying a lubricant to the sliding portion 102 where the second lens holder 64 abuts against and slides on the first lens holder 101, it is possible to make the sliding friction at the sliding portion 102 small when adjusting the relative positions of the first lens holder 101 and the second lens holder 64, so that it is possible to reduce a sliding load at the sliding portion 102. Therefore, it is possible to position the first lens holder 101 and the second lens holder 64 with high accuracy, and it is possible to adjust spherical aberration with high accuracy, that is, correct spherical aberration with high accuracy. In concrete, it is possible to correct spherical aberration so as to become the minimum.

Although the present embodiment describes such a configuration that a lubricant is applied to the sliding portion 102 where a sliding load is large, the configuration is not limited to the above one. In another embodiment of the invention, a lubricant may be applied to the entire sliding face formed by the outer periphery of the second lens holder 64 and the side portions of the convex portion 57 and the guiding portion 68 of the first lens holder 101: in other words, to the entire portion excluding both the circumferential ends 63 in a portion of the second lens holder 64 caused to slide in the first lens holder 101. In this configuration, it is possible to further reduce a sliding load at the portion where the second lens holder 64 abuts against and slides on the first lens holder 101. Consequently, it is possible to position the first lens holder 101 and the second lens holder 64 with higher accuracy as compared with when applying a lubricant to only the sliding portion 102, and it is possible to adjust spherical aberration with higher accuracy, that is, correct spherical aberration with higher accuracy.

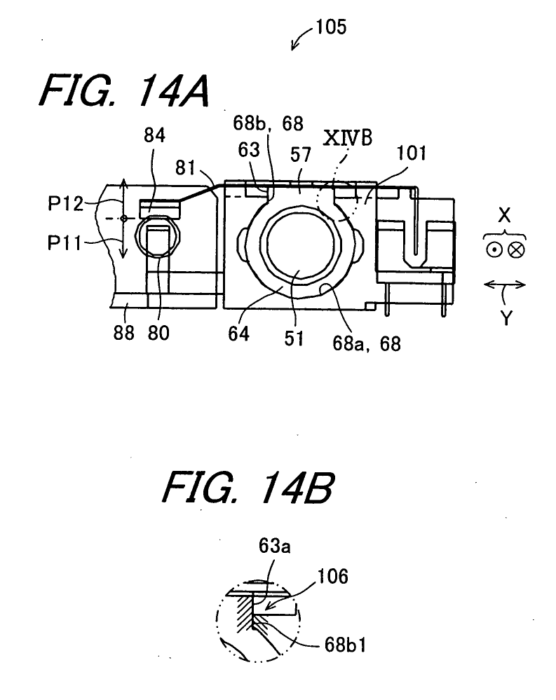

FIG. 14 is a simplified front view showing an optical adjustment device 105 according to a fifth embodiment of the invention. Since the optical adjustment device 105 of the present embodiment is similar in configuration to the optical adjustment device 100 of the fourth embodiment, the same components are denoted by the same reference numerals, and the descriptions thereof are omitted.

Since the grip rack 81 placed on the second lens holder 64 is disposed so that the locking portion 84 fits to the feed screw member 80 while applying the constant pressure P11 thereon, the reaction force P12 to the pressure P11 acts in exactly the opposite direction to a direction in which the pressure P11 acts.

In the present embodiment, a coating process is applied to a sliding portion where a sliding load is large due to the reaction force P12 acting on the grip rack 81, which is a sliding portion 106 formed by: the one circumferential end 63a located on the opposite side to a side facing the locking portion 84, of the convex portion 57 of the second lens holder 64; and the opening portion 68b1 located on the farther side from the locking portion 84, of the guiding portion 68 of the first lens holder 101. In FIG. 14, the sliding portion 106 is shown by hatching. Although coating formed on the sliding portion 106 is not limited in specific as far as the coating has a characteristic of reducing sliding friction, fluorinated coating is favorably used, for example.

As described above, according to the present embodiment, by applying a coating process for reducing sliding friction to the sliding portion 106 of the second lens holder 64, it is possible to make sliding friction at the sliding portion 106 small when adjusting the relative positions of the first lens holder 101 and the second lens holder 64, so that it is possible to reduce a sliding load at the sliding portion 106. Therefore, it is possible to position the first lens holder 101 and the second lens holder 64 with high accuracy, and it is possible to adjust spherical aberration with high accuracy, that is, correct spherical aberration with high accuracy. In concrete, it is possible to correct spherical aberration so as to become the minimum.

Although the present embodiment describes such a configuration that the coating process is applied to only the sliding portion 106, the configuration is not limited to the above one. In another embodiment of the invention, the coating process may be applied to the entire sliding face formed by the outer periphery of the second lens holder 64 and the side portions of the convex portion 57 and the guiding portion 68 of the first lens holder 101: in other words, to the entire portion excluding both the circumferential ends 63 in a portion of the second lens holder 64 caused to slide in the first lens holder 101. In this configuration, it is possible to further reduce a sliding load at the portion where the second lens holder 64 abuts against and slides on the first lens holder 101. Consequently, it is possible to position the first lens holder 101 and the second lens holder 64 with higher accuracy as compared with a case of applying the coating process to only the sliding portion 106, and it is possible to adjust spherical aberration with higher accuracy, that is, correct spherical aberration with higher accuracy.

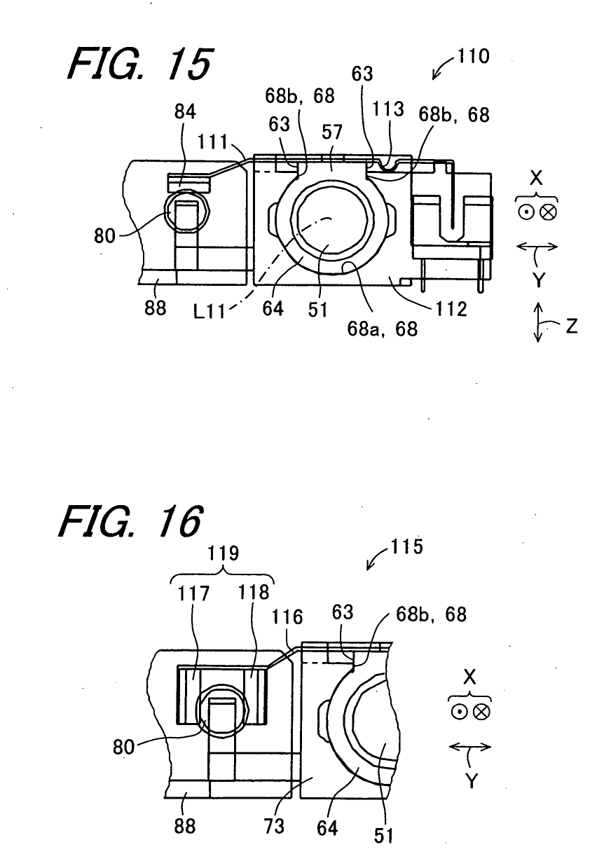

FIG. 15 is a simplified front view of an optical adjustment device 110 according to a sixth embodiment of the invention. Since the optical adjustment device 110 of the present embodiment is similar in configuration to the optical adjustment device 93 of the second embodiment, the same components are denoted by the same reference numerals, and the descriptions thereof are omitted. In the following embodiment, a direction perpendicular to both the approaching and leaving direction X and the Y-axis direction is defined as a “Z-axis direction.” Moreover, in the figure showing the optical adjustment device of the following embodiment, the Z-axis direction is represented with “Z.”

A grip rack 111 of the present embodiment is disposed to the second lens holder 64, and has the locking portion 84 disposed to the other longitudinal end of the grip rack 111, that is, to the other end in the Y-axis direction, and a projection 113 disposed to the other longitudinal end of the grip rack 111, that is, to the one end in the Y-axis direction and supported by the second lens holder 64.

The projection 113 is formed on the grip rack 111 so as to protrude in one direction of the Z-axis direction in the optical adjustment device 110, that is, in a direction approaching the first lens holder 112 in a state where the second lens holder 64 on which the grip rack 111 is placed is guided in a first lens holder 112. The projection 113 is formed into a semicircular shape in cross section perpendicular to the optical axis L11, that is, in cross section perpendicular to the approaching and leaving direction X, on a side abutting against the first lens holder 112. The projection 113 is formed, for example, by press-molding the grip rack 111 made of metal.

The projection 113 may be formed so as to extend in the direction of the optical axis L11, that is, in the approaching and leaving direction X, preferably, so as to extend over the full length of the grip rack 111 in the shorter side direction, that is, in the approaching and leaving direction X.

As described above, according to the present embodiment, since the projection 113 is formed on the grip rack 111, the projection 113 of the grip rack 111 slides on the first lens holder 112 when the relative positions of the first lens holder 112 and the second lens holder 64 are adjusted. Consequently, most of the sliding load is borne between the projection 113 of the grip rack 111 and the first lens holder 112 on which the projection 113 slides, and it is possible to reduce a sliding load at the sliding portion of the first lens holder 112 and the second lens holder 64.

Further, since the locking portion 84 of the grip rack 111 disposed to the second lens holder 64 is fitted to the feed screw member 80, and the projection 113 is supported by the second lens holder 64, it is possible to prevent the second lens holder 64 from unevenly contacting the guiding portion 68 of the first lens holder 112, when adjusting the relative positions of the first lens holder 112 and the second lens holder 64 to guide the second lens holder 64 on the guiding portion 68 of the first lens holder 112. Consequently, it is possible to reduce a sliding load of the first lens holder 112 and the second lens holder 64. Consequently, it is possible to position the first lens holder 112 and the second lens holder 64 with higher accuracy, and it is possible to adjust spherical aberration with higher accuracy, that is, correct spherical aberration with higher accuracy.

FIG. 16 is a simplified front view showing an optical adjustment device 115 according to a seventh embodiment of the invention. Since the optical adjustment device 115 of the present embodiment is similar in configuration to the optical adjustment device 93 of the second embodiment, the same components are denoted by the same reference numerals, and the descriptions thereof are omitted. In FIG. 16, only a characteristic part of the optical adjustment device 115 is shown.

In the optical adjustment device 115, a pair of locking portions that fit to the feed screw member 80, in concrete, a first locking portion 117 and a second locking portion 118 are disposed to a grip rack 116 as a detachment prevention portion 119 that prevents detachment from the feed screw member 80. The first and second locking portions 117 and 118 are disposed to the grip rack 116 so as to be spaced in the Y-axis direction and opposite to each other. The first and second locking portions 117 and 118 fit to the feed screw member 80 while holding the feed screw member 80 therebetween from both sides in the Y-axis direction.

As described above, according to the invention, a pair of locking portions disposed to the grip rack 116, in concrete, the first locking portion 117 and the second locking portion 118 fit to the feed screw member 80 while holding the feed screw member 80 therebetween. Consequently, it is possible to prevent that the first and second locking portions 117 and 118 are detached from the feed screw member 80 even when the feed screw member 80 is rotationally driven. In other words, it is possible to prevent the fitting state of the first and second locking portions 117 and 118 and the feed screw member 80 from being released when the feed screw member is rotationally driven.

Therefore, it is possible to prevent occurrence of a fault that the driving force of the driving source 75 cannot be transmitted to the grip rack 116 on which the first and second locking portions 117 and 118 are placed and the second lens holder 64 on which the grip rack 116 is placed. Consequently, it is possible to prevent occurrence of a fault that it is impossible to adjust spherical aberration, that is, correct spherical aberration.

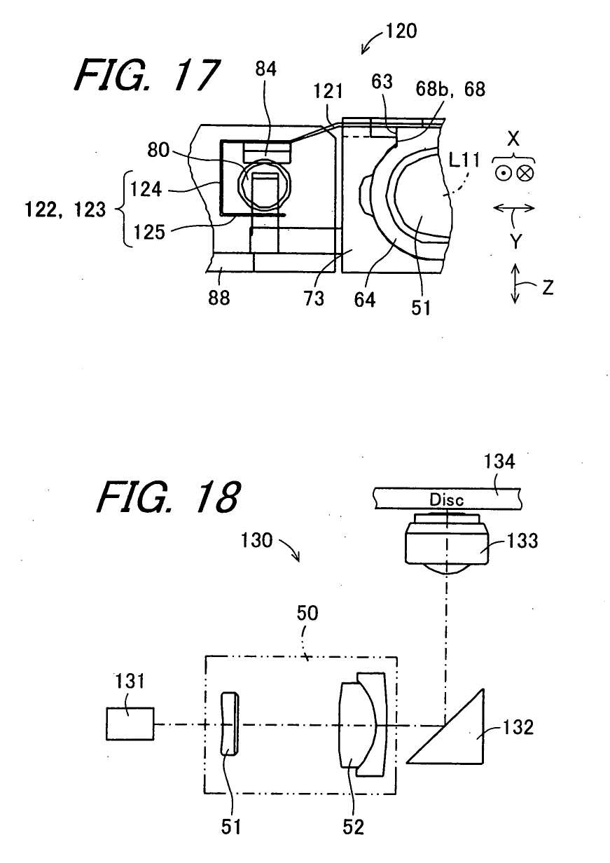

FIG. 17 is a simplified front view showing an optical adjustment device 120 according to an eighth embodiment of the invention. Since the optical adjustment device 120 of the present embodiment is similar in configuration to the optical adjustment device 93 of the second embodiment, the same components are denoted by the same reference numerals, and the descriptions thereof are omitted. In FIG. 17, only a characteristic part of the optical adjustment device 120 is shown.

In the optical adjustment device 120, a detachment prevention portion 122 for preventing that the locking portion 84 disposed to a grip rack 121 is detached from the feed screw member 80 is disposed to the grip rack 121. The detachment prevention portion 122 includes a surrounding portion 123 formed so as to be connected to the locking portion 84, more specifically, to a part of the grip rack 121 where the locking portion 84 is placed, extend to a position opposite to the locking portion 84, and surround the feed screw member 80.

For example, the surrounding portion 123 is made of metal, and formed in one body with the grip rack 121. The surrounding portion 123 includes a first connected portion 124 connected to the grip rack 121 and a second connected portion 125. The first connected portion 124 is a portion which is: extended from the part of the grip rack 121 where the locking portion 84 is placed, in the other direction of the Y-axis direction, concretely, in a direction leaving the first lens holder 73; bent 90 degrees at the part; and extended downward in the vertical direction, that is, extended in one direction of the Z-axis direction, concretely, in a direction approaching the base 88. The second connected portion 125 is a portion connected to the first connected portion 124 and bent 90 degrees at one end in the Z-axis direction of the first connected portion 124 to extend in the horizontal direction, that is, in one direction of the Y-axis direction, concretely, in a direction approaching the first lens holder 73, and the second connected portion is disposed so as to be opposite to the locking portion 84.

Therefore, the surrounding portion 123 is formed so as to be substantially L-shaped in cross section perpendicular to the optical axis L11, that is, in cross section perpendicular to the approaching and leaving direction X. A part obtained by adding the part of the grip rack 121 where the locking portion 84 is placed to the surrounding portion 123 is formed so as to be substantially U-shaped in cross section perpendicular to the optical axis L11, that is, in cross section perpendicular to the approaching and leaving direction X, and can surround the feed screw member 80 from both sides in the Z-axis direction and from the other side in the Y-axis direction of the feed screw member 80.

Since the surrounding portion 123 as described above is formed, the second connected potion 125 acts as a stopper for making the locking portion 84 hard to be detached from the feed screw member 80, so that the surrounding portion 123 functions as the detachment prevention portion 122. In the present embodiment, a clearance is created within a range where the locking portion 84 is not detached from the feed screw member 80, that is, the fitting state of the locking portion 84 and the feed screw member 80 is not released. Consequently, it is avoided that the second connected portion 125 and the feed screw member 80 abut against each other and are brought into a lock state, in a case where an abnormal load is put on the sliding portion of the first lens holder 73 and the second lens holder 64, or in a case where the driving source 75 operates off a control range.

As described above, according to the present embodiment, by disposing the surrounding portion 123, it is possible to securely prevent that the locking portion 84 is detached from the feed screw member 80. Consequently, it is possible to securely prevent occurrence of a fault that it is impossible to transmit the driving force of the driving source 75 to the second lens holder 64 on which the grip rack 121 is placed, namely, a fault that it is impossible to adjust spherical aberration, that is, correct spherical aberration.

FIG. 18 is a simplified view showing the configuration of an optical pickup apparatus 130. The optical pickup apparatus 130 comprises a light source 131 that emits light, the optical adjustment device 50, a raising mirror 132, and an objective lens 133. The optical pickup apparatus 130 is used at the time of execution of at least one of a process of writing information onto an optical disk 134 that is an optical recording medium and a process of reading out information from the optical disk 134.

The light source 131 is realized by, for example, a semiconductor laser device. The optical adjustment device 50 makes it possible to adjust the spherical aberration of an optical system with high accuracy, that is, correct the spherical aberration with high accuracy by adjusting the relative positions of the concave lens 51 and the convex lens 52 as described before. The raising mirror 132 bends 90 degrees the path of light emitted from the light source 131 and passed through the optical adjustment device 50, and causes the light to enter the objective lens 133. The objective lens 133, which is a condensing system, condenses light bent by the raising mirror 133 and entering therein and condenses onto the information recording surface of the optical disk 134.

As described above, according to the present embodiment, in the optical pickup apparatus 130 comprising the optical adjustment device 50, the driving force of the driving source 75 disposed to the optical adjustment device 50 is transmitted to the second lens holder 64 via the feed screw member 80 and the grip rack 81. Consequently, the second lens holder 64 can be displaced with respect to the first lens holder 73, so that it is possible to adjust the relative positions of the concave lens 51 and the convex lens 52, and it is possible to realize an optical pickup apparatus in which it is possible to adjust the spherical aberration of an optical system, that is, correct the spherical aberration.

Although FIG. 18 shows the configuration of the optical pickup apparatus 130 comprising the optical adjustment device 50 in order to make it easy to understand, an optical pickup apparatus comprising any one of the optical adjustment devices 93, 95, 100, 105, 110, 115 and 120 of the aforementioned second to eighth embodiments can embody in the same manner as the present embodiment, and can achieve the same effect.

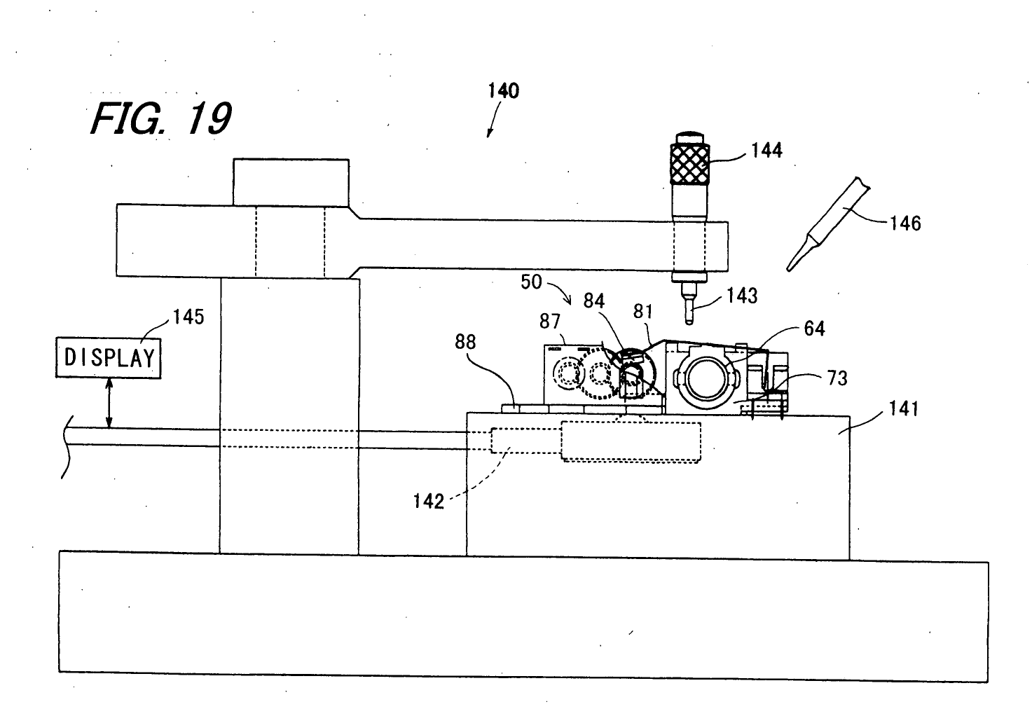

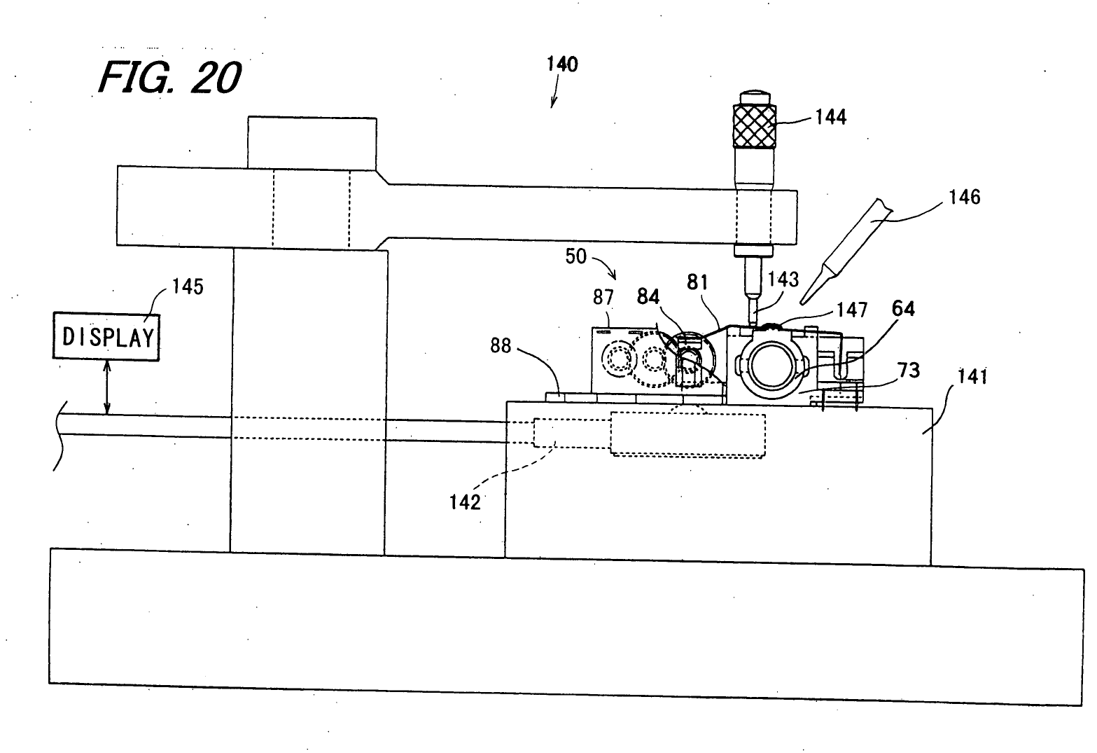

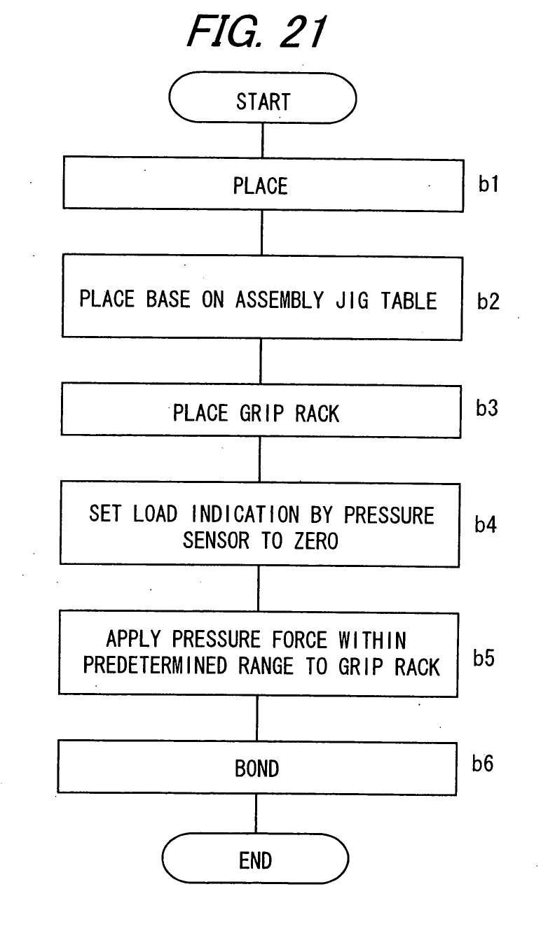

FIG. 19 is a front view showing an assembly apparatus 140 that assembles the optical adjustment device 50, and the optical adjustment device 50 placed on the assembly apparatus 140. FIG. 20 is a front view showing the assembly apparatus 140 and the optical adjustment device 50, in which the assembly apparatus 140 for assembling the optical adjustment device 50 is in a state where a pressure force within a predetermined range is applied to the grip rack 81 of the optical adjustment device 50 placed on the assembly apparatus 140. The assembly apparatus 140 for assembling the optical adjustment device 50 has an assembly jig table 141, a pressure sensor 142, a micrometer head 144 having a pin 143 serving as the pressing means, a display portion 145, and fixing means 146. The optical adjustment device 50 is assembled by the apparatus 140 for assembling the optical adjustment device 50.

Although assembly of the optical adjustment device 50 by the assembly apparatus 140 is described here in order to make it easy to understand, it is also possible to assemble the aforementioned optical adjustment devices 95, 100, 105, 110, 115 and 120 by the assembly apparatus 140.

FIG. 21 is a flowchart showing the procedure of a method for assembling the optical adjustment device 50. The procedure of the method for assembling the optical adjustment device 50 starts in a state where members, such as the second lens holder 64, the first lens holder 73, the driving source 75 and the grip rack 81, are prepared. At step b1, the first to fourth reduction gears 76 to 79, the feed screw member 80 and the driving source 75 are built into the gear storage table 87, and then the first lens holder 73, the second lens holder 64 and the gear storage table 87 are positioned and placed on the base 88. After the first lens holder 73, the second lens holder 64 and the gear storage table 87 are placed on the base 88, the procedure advances to step b2. At step b2, the base 88 on which the driving source 75 and so on have been placed at step b1 is placed on the assembly jig table 141 so as to abut against the pressure sensor 142. After the base 88 is placed on the assembly jig table 141, the procedure advances to step b3.

At step b3, the first top-face projection 58 and the second top-face projection 59 of the second lens holder 64 are fit into the rack hole 82 and the notch 83 of the grip rack 81, and the grip rack 81 is placed across the second lens holder 64 and the feed screw member 80. After the grip rack 81 is placed across the second lens holder 64 and the feed screw member 80, the procedure advances to step b4. At step b4, the indication on the display portion 145 by the pressure sensor 142 is set to zero. After the indication on the display portion 145 by the pressure sensor 142 is set to zero, the procedure advances to step b5.

At step b5, the micrometer head 144 is rotated, and the pin 143 of the micrometer head 144 abuts against the grip rack 81. By further rotation of the micrometer head 144, a pressure force is applied to the grip rack 81 in a direction approaching the feed screw member 80. Since the grip rack 81 is formed so as to have the mountain-shaped portion 85, the grip rack 81 is resiliently deformed. When a pressure force is applied to the grip rack 81, the pressure force is detected by the pressure sensor 142. Until a pressure force within a predetermined range, for example, a pressure force of not less than 10 g nor more than 20 g is detected by the pressure sensor 142, the micrometer head 144 applies a pressure force to the grip rack 81. After the pressure sensor 142 detects a pressure force within the predetermined range, rotation of the micrometer head 144 is stopped, and the procedure advances to step b6.

At step b6, in a state where a pressure force within the predetermined range is applied to the grip rack 81 at step b5 and the grip rack 81 is resiliently deformed as shown in FIG. 20, the rack hole 82 and the notch 83 of the grip rack 81 are fixed at an adhesion portion 147 to the first top-face projection 58 and the second top-face projection 59 of the second lens holder 64 by the fixing means 146, which is an adhesive. After fixing by the fixing means 146 is executed, the procedure of the method for assembling the optical adjustment device 50 ends. Steps b1 and b2 described before correspond to the placing step. Steps b3 to b6 correspond to the fixing step.

Although the procedure of the method for assembling the optical adjustment device 50 is shown in the flowchart shown in FIG. 21 in order to make it easy to understand, the aforementioned optical adjustment devices 93, 95, 100, 105, 110, 115 and 120 are also assembled in accordance with procedures similar to the procedure shown by the flowchart of FIG. 21.

In the present embodiment, a pressure force within the predetermined range applied by the micrometer head 144 to the grip rack 81 is set to not less than 10 g nor more than 20 g. In a case where a pressure force within the predetermined range is less than 10 g, the fitting of the locking portion 84 of the grip rack 81 and the feed screw member 80 is weak. Therefore, there is a possibility that, in a case where the feed screw member 80 rotates in accordance with driving of the driving source 75, and the grip rack 81 and the second lens holder 64 are displaced in the approaching and leaving direction X with respect to the first lens holder 73, the fitting state of the locking portion 84 of the grip rack 81 and the feed screw member 80 is released by external shock or the like and dislocation is caused.

On the other hand, in a case where a pressure force within the predetermined range exceeds 20 g, the fitting of the locking portion 84 of the grip rack 81 and the feed screw member 80 is strong. Therefore, in a case where the feed screw member 80 rotates in accordance with driving of the driving source 75, and the grip rack 81 and the second lens holder 64 are displaced in the approaching and leaving direction X with respect to the first lens holder 73, frictional force between the locking portion 84 of the grip rack 81 and the feed screw member 80 gets large, and a portion where the locking portion 84 of the grip rack 81 and the feed screw member 80 fit to each other is damaged. Moreover, the end on the side of the feed screw member 80 of both the circumferential ends 63 of the convex portion 57 of the second lens holder 64 and the end on the side of the feed screw member 80 of both the circumferential ends of the substantially C-shaped guiding portion 68 of the first lens holder 73 may be damaged by the frictional force.

Accordingly, by setting a pressure force within the predetermined range applied to the grip rack 81 to not less than 10 g nor more than 20 g, it is possible to prevent the fitting state of the locking portion 84 of the grip rack 81 and the feed screw member 80 from being released by external shock or the like, and it is possible to prevent the locking portion 84 of the grip rack 81, the feed screw member 80, the convex portion 57 of the second lens holder 64 and the guiding portion 68 of the first lens holder 73 from being damaged.

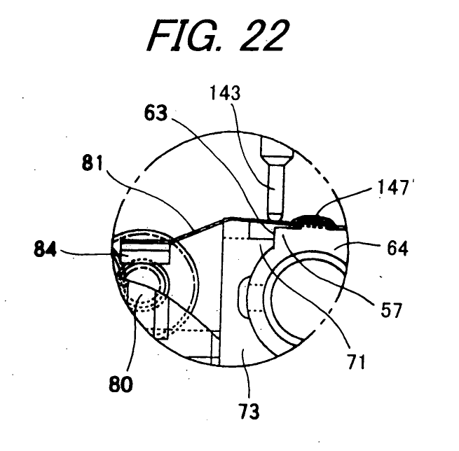

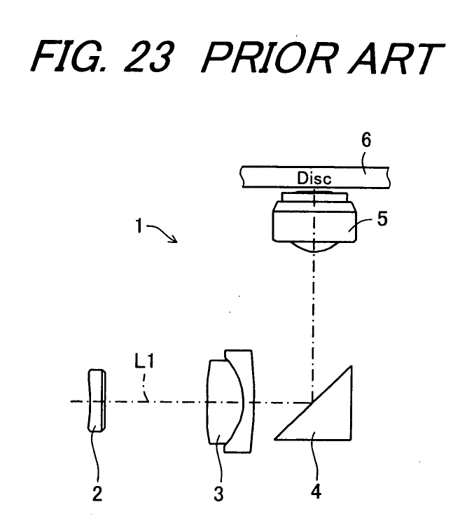

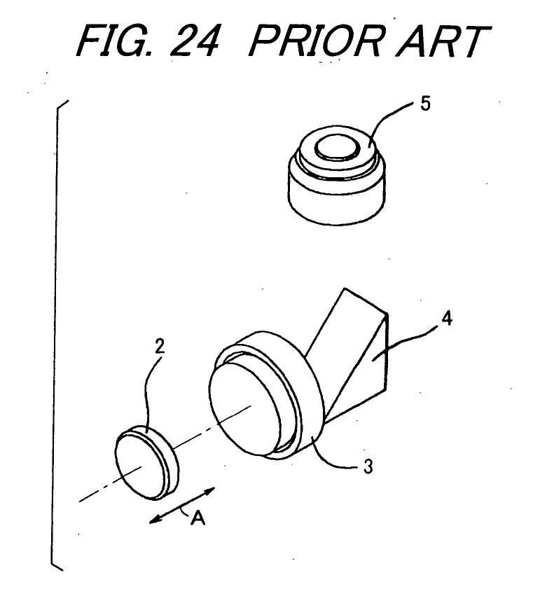

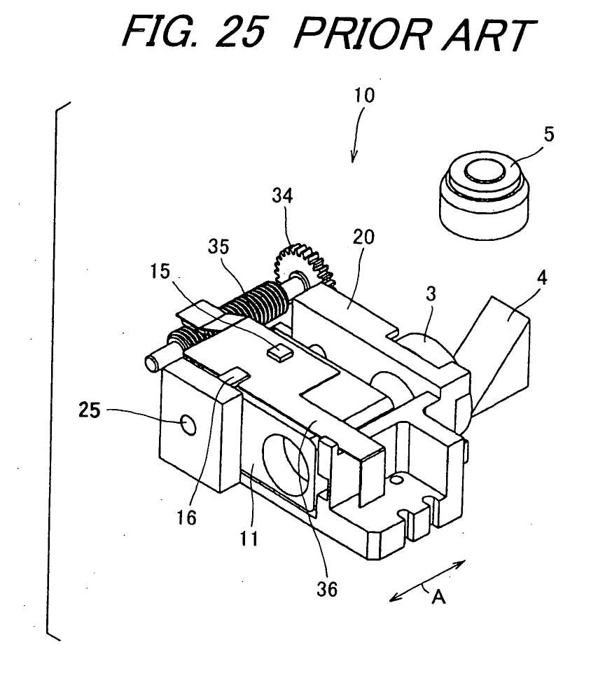

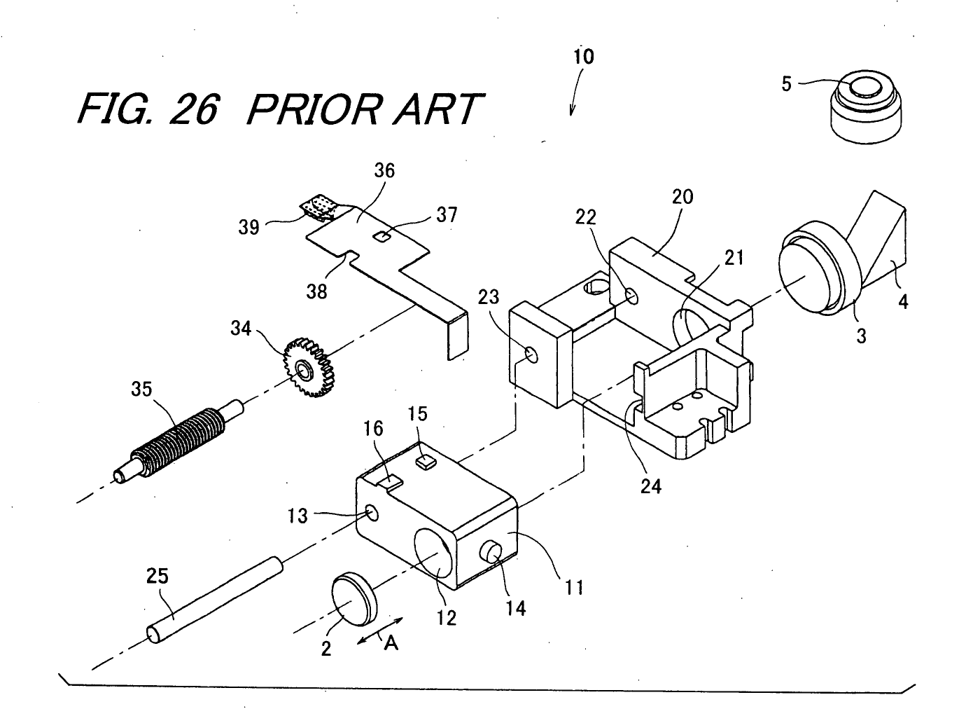

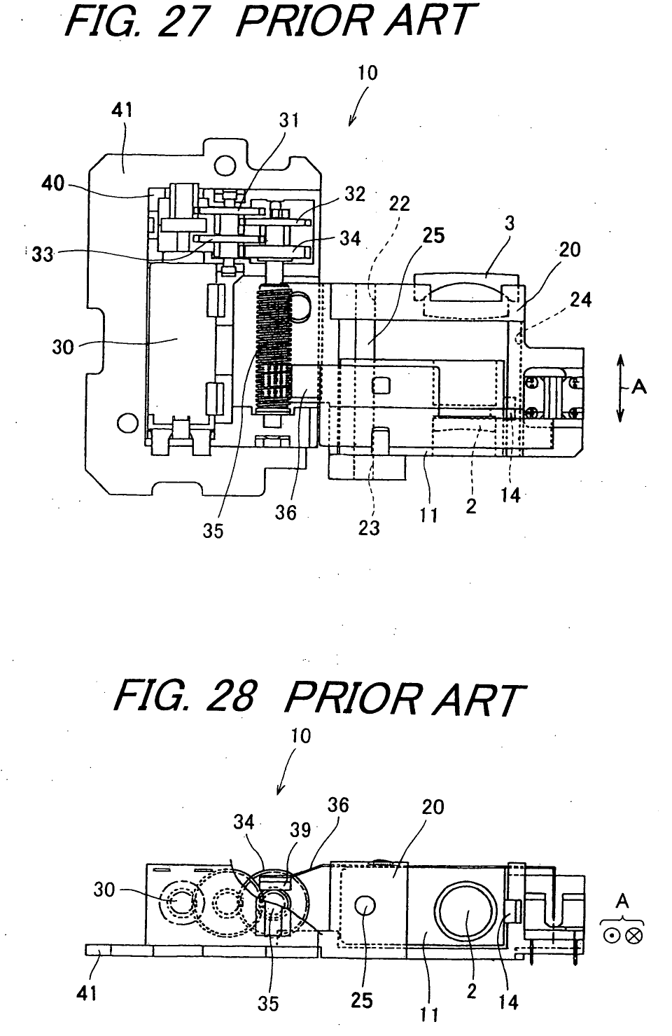

FIG. 22 is a magnified front view showing a part where the micrometer head 144 abuts against the grip rack 81 in the apparatus 140 for assembling the optical adjustment device 50 shown in FIG. 20. In the optical adjustment device 50, the grip rack 81 is configured so as to be resiliently deformed by a pressure force within a predetermined range. Therefore, a gap is created between the grip rack 81 and the convex portion 57 of the second lens holder 64 so that the grip rack can be resiliently deformed when a pressure force within the predetermined range is applied to the grip rack 81. For example, in a case where the gap for allowing the grip rack to be resiliently deformed is created, when a pressure force within the predetermined range is set to 15 g, the grip rack is resiliently displaced only by a pressure force of 15 g even if a pressure force of 20 g is applied thereto. Therefore, the optical adjustment device 50 is configured so that a gap is created between the grip rack 81 and the convex portion 57 of the second lens holder 64.

As described before, the grip rack 81 is placed across the second lens holder 64 and the feed screw member 80, and the locking portion 84 disposed to the grip rack 81 is provided so as to fit to the feed screw member 80. Further, the grip rack 81 is disposed so as to resiliently abut against the feed screw member 80 by an abutting force within a predetermined range. Consequently, the locking portion 84 of the grip rack 81 and the feed screw member 80 can fit to each other by the abutting force within the predetermined range. Therefore, when the feed screw member 80 is rotationally driven by the driving force of the driving source 75 and the grip rack 81 is displaced, the grip rack 81 can be displaced in accordance with rotation of the feed screw member 80 while the grip rack 81 maintains a constant abutting force against the feed screw member 80. Therefore, it is possible to prevent the fitting state of the feed screw member 80 and the grip rack 81 from being released by external shock or the like and dislocation from being caused. Moreover, it is possible to prevent that because an abutting force of the feed screw member 80 and the grip rack 81 is too large, frictional force is produced between the grip rack 81 and the feed screw member 80 and the respective members are damaged, and it is possible to realize the highly reliable optical adjustment device 55.

Further, the driving force of the driving source 75 is transmitted to the grip rack 81 via the feed screw member 80, and the grip rack 81 can be displaced in accordance with rotation of the feed screw member 80 while the grip rack 81 maintains a constant abutting force against the feed screw member 80, so that it is possible to displace the second lens holder 64 with respect to the first lens holder 73, and adjust the spherical aberration of an optical system of an optical pickup apparatus.

By the placing step and the fixing step, it is possible to fix the grip rack 81 to one of the first lens holder 73 and the second lens holder 64, in the present embodiment, to the second lens holder 64, in a state where a pressure force within a predetermined range in a direction approaching the feed screw member 80 is applied to the grip rack 81 and the grip rack 81 is resiliently deformed. Consequently, it is possible to provide the optical adjustment device 50 in which the locking portion 84 of the grip rack 81 and the feed screw member 80 can fit to each other while maintaining an abutting force within a predetermined range.

Further, the apparatus 140 for assembling the optical adjustment device 50 is provided with the micrometer head 144 serving as the pressing means that applies to the grip rack 81 a pressure force within a predetermined range in a direction causing the grip rack 81 to approach the feed screw member 80 and resiliently deforms the grip rack 81. The fixing means 146 is capable of fixing the grip rack 81 resiliently deformed by the micrometer head 144 to the second lens holder 64 in this state. Consequently, it is possible to apply a predetermined pressure force in a direction approaching the feed screw member 80 to the grip rack 81, and resiliently deform the grip rack 81. Moreover, it is possible to provide the optical adjustment device 50 in which the abutting force between the grip rack 81 and the feed screw member 80 can be maintained to be constant.

Further, since the cylindrical main body 56 of the second lens holder 64 is disposed so as to fit into the substantially C-shaped guiding portion 68 of the first lens holder 73, a characteristic large force will not be applied to the respective lens holders when the second lens holder 64 is displaced with respect to the first lens holder 73, so that it is possible to prevent rattling caused by wearing away or the like. Moreover, since the second lens holder 64 fits into the guiding portion 68 of the first lens holder 73 and is guided in the approaching and leaving direction X, it is possible to realize the optical adjustment device 50 in which the second lens holder 64 can be displaced with respect to the first lens holder 73 in a simple configuration.

Further, the second lens holder 64 is formed so that the convex portion 57 of the second lens holder 64 is formed on the upper side of the cylindrical main body 56, that is, formed in a direction from the raising mirror 53 to the objective lens 54 (simply referred to as “height direction” hereinafter), and the second lens holder 64 is fit into the first lens holder 73. Moreover, by configuring the optical adjustment device 50 so that the size in the height direction is smaller than the length between the raising mirror 53 and the objective lens 54, as compared with when forming the convex portion 57 in a direction (simply referred to as “Y-axis direction” hereinafter) which is perpendicular to both the approaching and leaving direction X and the direction from the raising mirror 53 to the objective lens 54, it is possible to reduce the size in the Y-axis direction, and it is possible to downsize the optical adjustment device.

The aforementioned embodiments merely exemplify the invention, and the configurations can be changed. For example, although the convex lens 52 is formed in pairs, the convex lens may be formed by a plurality of lenses or by one lens. Moreover, it is possible to configure so as to place the concave lens 51 on the first lens holder 73 and place the convex lens 52 on the second lens holder 64. Further, the screw-like member may be formed by a worm. Furthermore, the grip rack may be disposed across the first lens holder and the feed screw member. Besides, although the shield 91 is formed in one body with the grip rack 81 in the first embodiment, the shield 91 may be disposed separately from the grip rack 81.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. An optical adjustment device which adjusts the spherical aberration of an optical system of an optical pickup apparatus by adjusting relative positions of a first lens and a second lens, the optical adjustment device comprising:
a first lens holder having a substantially C-shaped guiding portion, for holding the first lens;
a second lens holder for holding the second lens, the second lens holder having one outwardly protruding convex portion formed in a circumferential direction thereof, the second lens holder being structured such as to fit into the guiding portion of the first lens holder and be freely displaceable with respect to the first lens holder by guidance of both circumferential ends of the convex portion by both circumferential ends of the guiding portion;
a driving source;
a screw-like member rotationally driven by the driving source; and
a connecting member which is provided on one of the first lens holder and the second lend holder and has a locking portion fitting to the screw-like member.

2. The optical adjustment device of claim 1, wherein the connecting member resiliently abuts against the screw-like member.

3. The optical adjustment device of claim 1, wherein the first lens holder has portions abutting against both the circumferential ends of the convex portion in the guiding portion; both the circumferential ends include one and the other circumferential ends; and the abutting portions are formed into curved shapes that protrude to at least one of the sides of the one and the other circumferential ends.

4. The optical adjustment device of claim 1, wherein the second lens holder includes a sliding portion which slides on the first lens holder and does not include both the circumferential ends, and
in the sliding portion, such portions are formed into curved shapes that are formed by one and the other ends in a displacement direction in which the second lens holder is displaced with respect to the first lens holder, and outer circumferential edges on the outer circumferential side in the radial direction of one and the other end face portions of the second lens holder.

5. The optical adjustment device of claim 1, wherein the second lens holder includes a sliding portion which slides on the first lens holder and does not include both the circumferential ends, and
a lubricant is applied to the sliding portion.

6. The optical adjustment device of claim 1, wherein the second lens holder includes a sliding portion which slides on the first lens holder and does not include both the circumferential ends, and
a coating process for reducing sliding friction is applied to the sliding portion.

7. The optical adjustment device of claim 1, wherein the connecting member is provided on the second lens holder, and has the locking portion disposed at one longitudinal end and a projection disposed at the other longitudinal end and supported by the second lens holder, and
at the time of adjustment of the relative positions of the first lens holder and the second lens holder, the projection of the connecting member slides on the first lens holder.

8. The optical adjustment device of claim 1, wherein the connecting member is provided with a detachment prevention portion which prevents the locking portion of the connecting member from being detached from the screw-like member.

9. The optical adjustment device of claim 8, wherein:
the detachment prevention portion includes a pair of locking portions placed so as to be opposite to each other, and
the pair of locking portions fit to the screw-like member while holding the screw-like member therebetween.

10. The optical adjustment device of claim 8, wherein the detachment prevention portion includes a surrounding portion formed so as to be connected to the locking portion, extend to a position opposite to the locking portion, and surround the screw-like member.

11. The optical adjustment device of claim 1, wherein the first lens holder is provided with a position sensor which detects the relative position to the second lens holder, and the second lens holder is provided with a detected portion which can be detected by the position sensor.

12. The optical adjustment device of claim 11, wherein the detected portion is formed in one body with the connecting member.

13. An optical pickup apparatus provided with the optical adjustment device of claim 1.

14. A method for assembling an optical adjustment device which comprises a first lens holder for holding a first lens, a second lens holder disposed so as to be freely displaced with respect to the first lens holder, for holding a second lens, a driving source, a screw-like member rotationally driven by the driving source, and a connecting member provided on one of the first and second lens holders and having a locking portion fitted to the screw-like member, and which optical adjustment device adjusts the spherical aberration of an optical system of an optical pickup apparatus by adjusting the relative positions of the first lens and the second lens, the method for assembling the optical adjustment device comprising:
a placing step of positioning and disposing the first and second lens holders, the driving source, and the screw-like member; and
a fixing step of fixing the connecting member to either the first or the second lens holder by disposing the connecting member across the either the first or the second lens holder and the screw-like member, and resiliently deforming the connecting member by applying to the connecting member a pressing force within a predetermined range in a direction in which the connecting member approaches the screw-like member.

15. An apparatus for assembling an optical adjustment device which comprises a first lens holder for holding a first lens, a second lens holder disposed so as to be freely displaced with respect to the first lens holder, for holding a second lens, a driving source, a screw-like member rotationally driven by the driving source, and a connecting member provided on one of the first and second lens holders and having a locking portion fitted to the screw-like member, and which optical adjustment device adjusts the spherical aberration of an optical system of an optical pickup apparatus by adjusting the relative positions of the first lens and the second lens, the apparatus for assembling the optical adjustment device comprising:
pressing means for applying a pressing force within a predetermined range in a direction where the connecting member approaches the screw-like member, to a precursor where the first and second lens holders, the driving source and the screw-like member are positioned and disposed and the connecting member is placed across one of the first and second lens holders and the screw-like member, thereby resiliently deforming the connecting member; and
fixing means for fixing the connecting member to one of the first and second lens holders.
